(19) United States
(12) Patent Application Publication
(10) Pub. No.: US 2015/0127438 A1
(43) Pub. Date: May 7, 2015

(54) SYSTEMS AND METHODS FOR MANAGING A RETAIL NETWORK

(71) Applicant: R&D Consulting Professionals Inc., Moncton (CA)

(72) Inventors: James Wedderburn, Moncton (CA); Tom McLellan, Toronto (CA); Rick Auffrey, Moncton (CA); Amanda Cormier, Grand-Barachois (CA)

(21) Appl. No.: 14/391,551

(22) PCT Filed: Apr. 9, 2013
(86) PCT No.: PCT/CA2013/050282

§ 371 Date: Oct. 9, 2014

Related U.S. Application Data
(60) Provisional application No. 61/621,998, filed on Apr. 9, 2012.
(60) Provisional application No. 61/725,475, filed on Nov. 12, 2012.

(51) Int. Cl. G06Q 30/02

(52) U.S. Cl. CPC G06Q 30/0214; G06Q 30/0246
USPC 705/14.16

(57) ABSTRACT

Methods and systems for managing a retail network, the retail network including at least one manufacturer and/or merchant of a product or service; at least one retail or non-retail affiliate for promoting the product or service; and a retail network agent having a processor configured to execute computer readable instructions to manage retail transactions between the at least one manufacturer and/or merchant and the at least one affiliate.

### CROSS-REFERENCE TO RELATED APPLICATION

The present disclosure claims priority from U.S. provisional patent application No. 61/621,998, filed Apr. 9, 2012, and U.S. provisional patent application No. 61/725,475, filed Nov. 12, 2012, the entireties of which are hereby incorporated by reference.

### TECHNICAL FIELD

The present disclosure relates generally to retail network systems and methods. In particular, the present disclosure relates to systems and methods for managing a retail affiliate network.

### BACKGROUND

Conventionally, mass merchandisers have used the power of volume to extract low prices from product manufacturers, typically without allowing manufacturers to have direct customer relationships. Mass merchandisers can put manufacturers out of business by suddenly deciding to stop carrying their product. The manufacturer typically has little or no control over volume and price when selling through mass merchandisers. Through the power of mass purchasing and analytics-based retail optimization, mass merchandisers are usually able to offer consumers lower prices than independent retailers.

It would be useful to offer an alternative to this conventional retail model.

### SUMMARY

In some example aspects, the present disclosure provides a system for managing a retail network, the system comprising a processor configured to execute computer readable instructions to cause the system to: manage retail transactions between at least one manufacturer and/or merchant of a product or service and at least one retail affiliate having a physical space for showcasing the product or service; wherein managing retail transactions include: providing at least one promotional material to the at least one retail affiliate, for promoting the product or service in the physical space of the at least one retail affiliate; providing affiliate-specific data to each of the at least one retail affiliate for communication to one or more consumers, the affiliate-specific data being unique to each of the at least one retail affiliate and usable by the one or more consumers for online purchase of the product or service; tracking online purchase of the product or service by the one or more consumers, and attributing the online purchase as a referral by a particular one of the at least one retail affiliate, using the affiliate-specific data; and managing transfer of compensation from the at least one manufacturer and/or merchant to the particular one retail affiliate, as a result of the tracked online purchase.

In some example aspects, the present disclosure provides a system for managing a retail network, the system comprising a processor configured to execute computer readable instructions to cause the system to: manage retail transactions between at least one manufacturer and/or merchant of a product or service and at least one affiliate, the at least one affiliate being a retail or non-retail entity for promoting the product or service; track online purchase of the product or service by one or more consumers and attribute the online purchase as a referral by a particular one of the at least one affiliate; and manage transfer of compensation from the at least one manufacturer and/or merchant to the particular one affiliate, as a result of the tracked online purchase.

In some example aspects, the present disclosure provides a retail network comprising: at least one manufacturer and/or merchant of a product or service; at least one retail or non-retail affiliate for promoting the product or service; and a retail network agent having a processor configured to execute computer readable instructions to manage retail transactions between the at least one manufacturer and/or merchant and the at least one affiliate.

In some example aspects, the present disclosure provides a system for analyzing retail promotions, the system comprising a processor configured to execute computer readable instructions to cause the system to: provide at least one promotional program from at least one manufacturer and/or merchant of a product or service to at least one retail affiliate having a physical space for showcasing the product or service, the promotional program to be implemented by the at least one retail affiliate in the physical space; wherein the promotional program defines at least one variable related to promotion of the product or service in the physical space, and includes at least one promotional material for promoting the product or service in the physical space; wherein the promotional material includes affiliate-specific data for distribution to one or more consumers, the affiliate-specific data being unique to each of the at least one retail affiliate and usable by the one or more consumers for online purchase of the product or service; track online purchase of the product or service by the one or more consumers, and attribute the online purchase as resulting from a particular promotional program, using the affiliate-specific data; and perform an analysis of any influence of the at least one variable defined in the particular promotional program on online purchases of the product or service. In some example aspects, the present disclosure provides a system for promoting a product or service, the system comprising a processor configured to execute computer readable instructions to cause the system to: manage retail transactions between at least one manufacturer and/or merchant of a product or service and at least one entity affiliate; wherein managing retail transactions include: providing the at least one entity affiliate with promotional material for promoting the product or service to one or more contacts; generating and providing to the at least one entity affiliate affiliate-specific data unique to each of the at least one entity affiliate, the affiliate specific data being communicable to the one or more contacts and usable by the one or more contacts for online purchase of the product or service; tracking online purchase of the product or service by the one or more contacts, and attributing the online purchase as a referral by a particular one of the at least one entity affiliate, using the affiliate-specific data; and managing transfer of compensation from the at least one manufacturer and/or merchant to the particular one entity affiliate, as a result of the tracked online purchase.

In some example aspects, the present disclosure provides a system for managing a retail network, the system comprising a processor configured to execute computer readable instructions to cause the system to: manage retail transactions with at least one affiliate; wherein managing retail transactions include: providing promotional material to the at least one affiliate; generating and providing affiliate-specific data to each of the at least one affiliate for communication to one or more consumers, the affiliate-specific data being unique to each of the at least one affiliate and usable by the one or more consumers for online purchase of the product or service; tracking online purchase of the product or service by the one or more consumers, and attributing the online purchase as a referral by a particular one of the at least one affiliate, using the affiliate-specific data; and managing transfer of compensation to the particular one affiliate, as a result of the tracked online purchase.

### BRIEF DESCRIPTION OF THE DRAWINGS

Reference will now be made to the drawings, which show example embodiments of the present disclosure, and in which:

FIG. 1 is a diagram illustrating an example conventional retail model;

FIG. 2 is a diagram illustrating an example retail model in accordance with the present disclosure;

FIG. 3 is a schematic illustrating an example system for managing a retail network, in accordance with the present disclosure;

FIG. 4 is a schematic illustrating an example network management server suitable for use in the example system of FIG. 3;

FIG. 5 is a flowchart illustrating an example method for adding a manufacturer merchant to a retail network, which method may be carried out by the example system of FIG. 3;

FIG. 6 is a flowchart illustrating an example method for managing retail promotions, which method may be carried out by the example system of FIG. 3;

FIG. 7 is a flowchart illustrating an example method for gathering retail information, which method may be carried out by the example system of FIG. 3;

FIG. 8 is a flowchart illustrating an example method for remarketing, which method may be carried out by the example system of FIG. 3;

FIG. 9 is a flowchart illustrating an example method for implementing coupons, which method may be carried out by the example system of FIG. 3;

FIG. 10 is a flowchart illustrating an example method of co-promoting using coupons, which method may be carried out by the example system of FIG. 3;

FIG. 11 is a flowchart illustrating an example method for recruiting a referred consumer as a new affiliate, which method may be carried out by the example system of FIG. 3;

FIG. 12 is a flowchart illustrating an example method for managing a product preview, which method may be carried out by the example system of FIG. 3;

FIG. 13 is a flowchart illustrating an example method for promoting a new product, which method may be carried out by the example system of FIG. 3;

FIG. 14 is a flowchart illustrating an example method for managing virtual retail, which method may be carried out by the example system of FIG. 3;

FIG. 15 is a flowchart illustrating an example method for promoting a product via a catalogue, which method may be carried out by the example system of FIG. 3;

FIG. 16 is a flowchart illustrating an example method for promoting a product in a non-retail environment, which method may be carried out by the example system of FIG. 3;

FIG. 17 is a flowchart illustrating an example method for promoting a product in a retail environment, which method may be carried out by the example system of FIG. 3;

FIG. 18 is a flowchart illustrating an example method for promoting a product in a consumer environment, which method may be carried out by the example system of FIG. 3;

FIG. 19 is a flowchart illustrating an example method for managing use of a gift card, which method may be carried out by the example system of FIG. 3;

FIG. 20 is a flowchart illustrating an example method for attributing referrals based on location, which method may be carried out by the example system of FIG. 3;

FIG. 21 is a flowchart illustrating an example method for managing compensation resulting from multi-step referrals, which method may be carried out by the example system of FIG. 3;

FIG. 22 is a diagram of an example in-store display, in accordance with an example of the present disclosure;

FIG. 23 is a diagram of an example promotional card; in accordance with an example of the present disclosure;

FIG. 24 is a diagram of another example promotional card, in accordance an example of with the present disclosure;

FIG. 25 is a diagram of an example website, in accordance with an example of the present disclosure;

FIG. 26 is a diagram of an example shelf label, in accordance with an example of the present disclosure;

FIG. 27 is a diagram illustrating placement of the example shelf label of FIG. 26 on a product shelf;

FIG. 28 is a diagram illustrating an example software application, in accordance with an example of the present disclosure; and

FIG. 29 is a flowchart illustrating an example method for promoting products and/or services over a dedicated retail social network.

It will be noted that throughout the appended drawings, like features are identified by like reference numerals.

### DETAILED DESCRIPTION

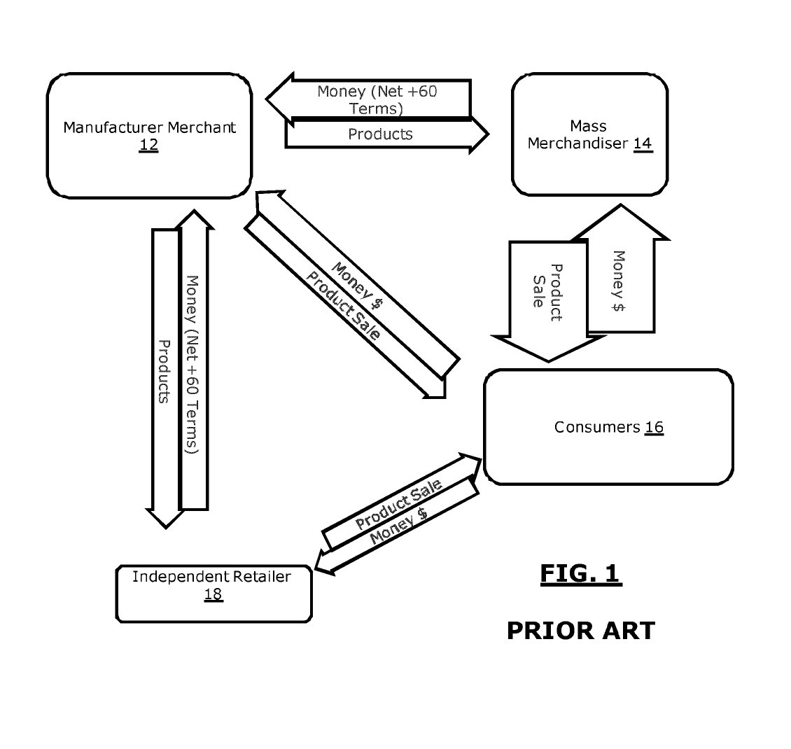

FIG. 1 shows an example conventional retail model. In the conventional model a manufacturer merchant 12 may wish to sell products to consumers 16 (who may include online consumers, offline consumers, retail consumers and referred consumers). Avenues for selling products include selling through a mass merchandiser 14 and selling through an independent retailer 18. The manufacturer merchant 12 may also attempt to sell directly to consumers 16, for example through an e-commerce site owned and/or managed by the manufacturer merchant 12.

Such a model may include drawbacks, such as:
Manufacturer merchants 12 typically do not have enough traffic at its e-commerce site to sell directly to consumers 16, so the manufacturer merchant 12 typically is dependent heavily on the mass merchandiser 14. The mass merchandiser 14 is able to take advantage of this dependency to negotiate large discounts on high volume orders from the manufacturer merchant 12.
Consumers 16 may use the practice of “showrooming”, where a consumer 16 inspects a product in retail stores but buys the product online to get lower price. This may be disadvantageous to the retailer (whether a mass merchandiser 14 or an independent retailer 18) since the retailer carries the cost of inventory and display of the product, along with other overhead costs, without reaping the profit of selling the product.
Independent retailers 18 typically lack the buying power, economies of scale, and/or analytics of mass merchandisers 14, and are typically ill-equipped to sell and compete online. As such, independent retailers 18 are easily undercut and squeezed out of a market by mass merchandisers 14.

There has been interest in online affiliate marketing, which typically aims to broker relationships and commissions between manufacturer merchants 12 and online affiliates (e.g., website publishers, bloggers, e-magazine publishers and online stores). The conventional affiliate marketing industry is typically based on online-only relationships between website and email marketing publishers, and online stores. As a subset of the online retail industry, the affiliate marketing industry is still emerging, and focuses typically on publishers and online merchants that operate e-commerce stores. The conventional affiliate marketing industry typically does not serve independent retailers 18, possibly due to the practical challenge of tracking purchases that originate in a physical retail setting. Further, conventional affiliate marketing techniques typically are not concerned with physical retail space.

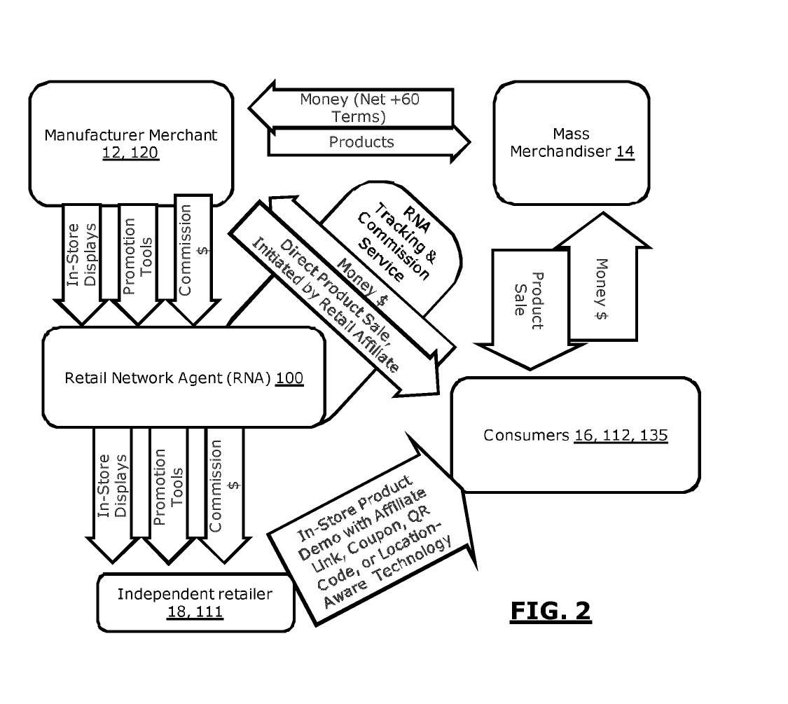

FIG. 2 shows an example retail model that may be enabled by the present disclosure.

In this example retail model, the manufacturer merchant 12 may be an affiliate manufacturer merchant 120 (described further below) who is part of a retail affiliate network (which may also be referred to as a retail network or an affiliate network) managed by retail network agent (RNA) 100 (described further below). The independent retailer 18 may be a retail affiliate 111 (described further below) who is part of the retail affiliate network. The consumer 16 may be an entity affiliate 112 (described further below) with the retail affiliate network, or a non-affiliate 135.

As in the conventional retail model, the manufacturer merchant 12, 120 may manufacture products and may sell products via its own e-commerce site. The manufacturer merchant 12, 120 may have the same relationship with the mass merchandiser 14, as described in FIG. 1.

Through the retail affiliate network, which may be managed by the RNA 100, the manufacturer merchant 12, 120 may promote its products through a network of independent retailers 18, 111 (which may number in the 100s, 1000s, or more), while keeping control over price and inventory, and achieving a direct sale relationship with consumers 16, 112, 135.

The mass merchandisers 14 may gradually become a secondary, lower margin channel to market for the manufacturer merchant 12, 120.

The consumers 16, 112, 135 may include retail consumers, online consumers, offline consumers, referred consumers as well as consumers on social media. The consumer 16, 112, 135 may continue the practice of showrooming, however through management by the RNA 100 retailers (e.g., retail affiliates 111) may earn commissions for sales resulting from showrooming products in their retail space. This may be beneficial for retailers, particularly smaller retailers, since commissions may be earned from showcasing a wider range of products with little or no inventory costs.

Promotional material (e.g., in-store displays, coupons and other promotional tools) for a product may be provided to a retail affiliate 111 by a manufacturer merchant affiliate 120 and/or by the RNA 100. Consumer actions (e.g., purchase of a promoted product or visit to manufacturer's website) may be tracked through the use of a unique affiliate link, coupon, QR code, location-aware technology or other methods. The consumer 16, 112, 135 may purchase a product directly from the manufacturer merchant affiliate 120 (e.g., via manufacturer's website), and this purchase may be tracked, by the RNA 100, to be the result of a physical visit to the retail affiliate 111. The RNA 100 may then broker a commission from the manufacturer merchant 120 to the retail affiliate 111 for the direct sale. Further details and variations are provided further below.

The retail model enabled by the present disclosure may diminish the power of the mass merchandiser 14 chain, and may empower the affiliated manufacturer merchant 120 and affiliated independent retailer 111. The affiliated manufacturer merchant 120 may be able to directly control price and/or commissions to affiliated retailers 111, and affiliated independent retailers 111 may be able to leverage large scale analytics (which may be provided by the RNA 100) and/or competitive pricing to offer consumers 16, 112, 135 a wider range of products without conventional inventory costs. This retail model may allow the affiliated independent retailer 111 to compete against mass merchandisers 14, while enabling direct relationships between the affiliated manufacturer merchant 120 and the consumer 16, 112, 135. Consumers 16, 112, 135 visiting a physical retail store may be driven to a manufacturer's website for direct purchasing of the product online. This may be organized and brokered by the central RNA 100.

The conventional has been mass merchandizing. The RNA 100 may enable affiliated independent retailers 111 (which may include small businesses and individuals) to make offers that may be competitive with larger mass merchandisers 14 by reducing or eliminating the conventional costs and lack of analytics that are typically a challenge for independent retailers 18.

Some possible advantages provided by the present disclosure include, for example:
The ability to allow a non-retail entity who does not have conventional retail space or inventory capacity to act as a retailer. Any entity that has foot traffic (e.g., a service shop such as a garage) but does not have capacity for inventory may start retailing using the systems and methods of the present disclosure, with little or none of the cost and/or complexity of inventory.
The RNA 100 may help smaller affiliated manufacturers 120 to bring products to market more easily, for example by tapping into a pre-established network of lower-overhead affiliated retailers 111, who may promote the manufacturer's products on a post-sale commission model. This relationship between the affiliated manufacturer 120 and the affiliated retailer 111 may be brokered by the RNA 100, who may act as a trusted third-party.
As a trusted entity, the RNA 100 may provide retailer affiliates 111 with an opportunity to earn ongoing income, for example resulting from entity affiliates 112 who are exposed to products in physical retail locations and agree to promote products and/or offers to friends and/or contacts (e.g., through social media and other online or offline methods).
The RNA 100 may help to centralize relationships and operations that may otherwise be loose and/or one-to-one between manufacturers 120 and retailers 111. For example the RNA 100 may offer retail locations and/or kiosks featuring top manufacturer merchants 120 to retail affiliates 111. The RNA 100 may also provide centralized warehouses for direct pickup of products by consumers 16, 112, 135. In this way, retail space may be optimized for showroom experiences while inventory management and warehousing may be centralized and consolidated to reduce inventory costs. The practice of showrooming by consumers 16, 112, 135 may thus be counter-intuitively made into an advantage and may be leveraged to the benefit of the retailer 111.

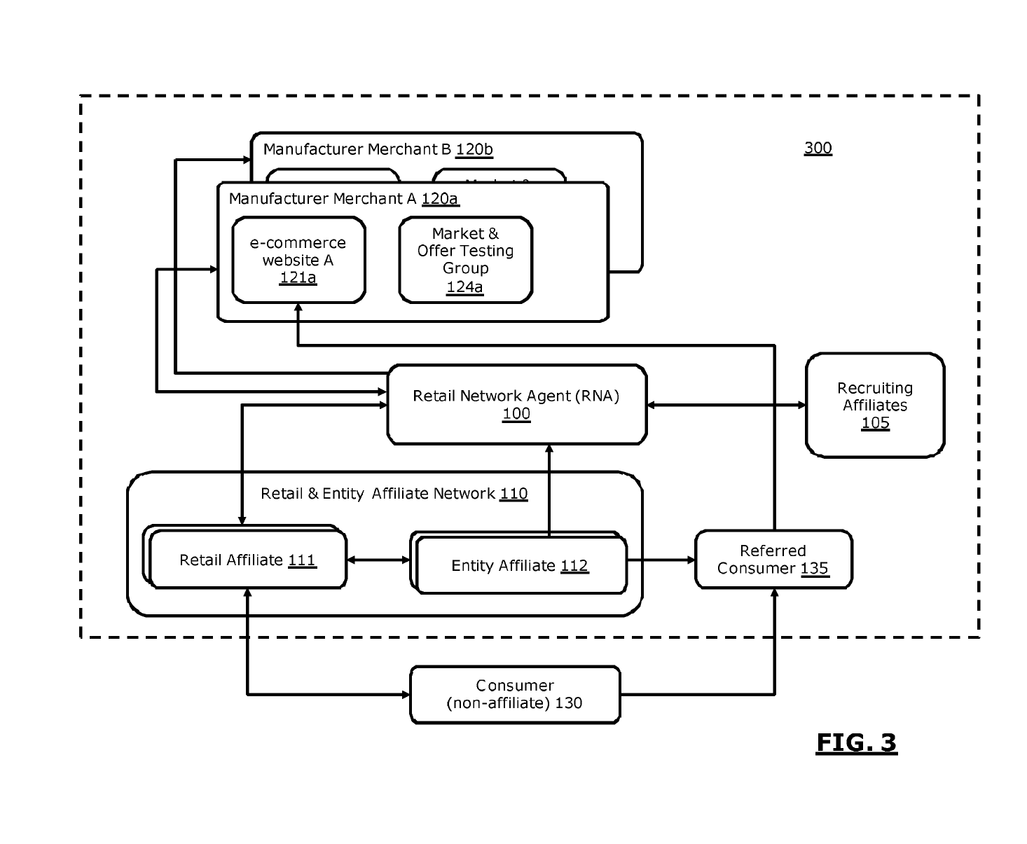

FIG. 3 is a schematic diagram of an example system 300 for managing a retail network, in accordance with the present disclosure. The system 300 may generally be referred to as a retail network or an affiliate network.

The retail network agent (RNA) 100 may act as a broker for affiliate relationships among affiliated manufacturer merchants 120 (also referred to as manufacturer merchants 120 or manufacturers 120), retail affiliates 111 (also referred to as retailers 111), entity affiliates 112, and referred consumers 135. The RNA 100 may serve generally as a broker or a relationship manager, as a trusted third-party that manages transactions among manufacturer merchants 120, retail affiliates 111 and entity affiliates 112.

An entity affiliate 112 may be any suitable entity including, for example, a consumer, a magazine or a non-retail organization (e.g., a fundraising organization or a school), and may have an online-only presence, an offline-only presence or both online and offline presence. In the present disclosure, where an entity affiliate 112 is a consumer, the entity affiliate 112 may be referred to as a consumer 112, or the term “consumer affiliate” may be used. A consumer may also be a non-affiliate consumer 130, who may not yet be part of the system 300. A consumer 112, 130, 135 may be a retail consumer, an online consumer or an offline consumer, and a single consumer 112, 130, 135 may take on a combination of these roles. The group of retail affiliates 111 and entity affiliates 112 may define a retail & entity affiliate network 110.

There may be a plurality of manufacturer merchants 120a, 120b (generally referred to as manufacturer merchants 120), each with their respective product(s). Each manufacturer merchant 120 may own and/or manage its own e-commerce website 121a, 121b (generally referred to as e-commerce websites 121 or simply as websites 121) and/or its own market & offer testing group 124a, 124b (generally referred to as market & offer testing groups 124 or simply as test groups 124). Each manufacturer merchant 120 may have its own target market, promotions, marketing material and/or other unique attributes. Such attributes may be tracked and/or managed by the RNA 100, as described further below.

The RNA 100 may track actions (including revenue-generating actions, such as purchases), such as actions between a referred consumer 135 and a manufacturer merchant 120 (e.g., through the manufacturer's e-commerce website 121), and may broker related commissions. The RNA 100 may be responsible for recruiting (e.g., with the aid of recruiting affiliates 105, who may include any one or more of manufacturer merchants 120, retail affiliates 111 and entity affiliates 112), developing and/or managing the retail & entity affiliate network 110 and manufacturer merchants 120.

The retail affiliate 111 may be a retailer, retail chain, or other retail organization with physical locations (e.g., a retail store and/or other non-retail space) that may be visited by consumers 112, 130, 135. In some examples, the retail affiliate 111 may not be a traditional retailer (e.g., may not be a conventional seller of products and may not have conventional retail space) but may still be visited by consumers 112, 130, 135. The retail affiliate 111 may promote one or more products from one or more manufacturer merchants 120 through, for example, physical in-store displays and/or electronic displays to their in-store customers. The retail affiliate 111 may have an agreement with the RNA 100 whereby the retail affiliate 111 may receive affiliate compensation (e.g., a sales commission or “cost per action”) as a result of promoting product(s) from manufacturer merchant(s) 120 to non-affiliate retail consumers 130 or organizations, which may become referred consumers 135 or entity affiliates 112. A “cost per action” (CPA) may be a flat fee compensation earned for a measurable action (which may or may not be a revenue-generating action), such as a consumer's visit to a retail store, visit to a website, registration for a web-based offer, or other such actions.

The entity affiliate 112 may be an individual or an organization which has an agreement with the RNA 100 to promote product(s) and/or website(s) 121 of the manufacturer merchant(s) 120, typically in exchange for affiliate compensation (which may or may not be of a monetary nature). The entity affiliate 112 may have been referred to the RNA 100 by another entity affiliate 112 or another retail affiliate 111. The entity affiliate 112 may have an online presence (e.g., a social media presence) through which other consumers may be reached.

Different types of compensation may be provided to the affiliate 111, 112 including, for example, money, credit with the network 300, gifts, charitable donation and/or promotion to higher status, among other possibilities. The affiliate 111, 112 may be able to choose the type of compensation earned. The affiliate 111, 112 may also be able to access a database of the RNA 100 (described further below) using a user interface provided by the RNA 100 (e.g., a secure web portal) to manage its preferences (e.g., selection of the type of compensation earned), track its history (e.g., number of referrals, number of visits to a website 121 or amount of compensation paid or earned), view and search for available affiliate programs to join, manage a virtual store (described further below), manage a social media presence, and receive electronic promotional material (e.g., affiliate-specific links or promo codes) from the RNA 100, for example.

Compensation may be delivered by the RNA 100 to the affiliate 111, 112 in the form of direct deposit to an account, delivery of a physical cheque, deposit of credits in the affiliate's 111, 112 profile managed by the RNA 100, or any other suitable method.

The non-affiliate consumer 130 may be an individual who may not yet be part of the retail & entity affiliate network 110 and not yet be a referred consumer 135. The non-affiliate consumer 130 may initially come into contact with a promotion and/or a product from a manufacturer merchant 120 through visiting a retail store or other physical location, receiving direct mail, print advertising, or through other offline channels that may be managed and/or provided by the retail affiliate 111, for example.

A referred consumer 135 may be an individual who engages with the manufacturer merchant 120 as a result of exposure to a promotion or offer from a retail affiliate 111 or an entity affiliate 112. The referred consumer 135 may be an online consumer. In responding to the promotion or offer, the referred consumer 135 may visit the manufacturer's e-commerce website 121, and any resulting online actions (including product sales or other commissionable actions) may be tracked by the RNA 100 (e.g., through the use of tracking technology, including by associating tracking information with the consumer 135, such as web browser cookies). The RNA 100 may compensate the originating retail affiliate 111 and/or entity affiliate 112 that caused the referred consumer 135 to be exposed to the promotion. A referred consumer 135 may be affiliated or not affiliated with the retail & entity affiliate network 110.

The manufacturer merchant 120 may be an organization that may have an e-commerce website 121 (e.g., an online store) and may sell products and/or services to referred consumers 135 directly. The website 121 may be accessible using a web browser through the Internet, for example. The manufacturer merchant 120 may be the original product manufacturer. The manufacturer merchant 120 may alternatively be a merchant (e.g., an online merchant) selling one or more products from one or more manufacturers.

The manufacturer merchant 120 may act as a cross-promoting affiliate by promoting product(s) of other affiliated manufacturer merchants 120. For example, manufacturer merchant A 120a may have a set of direct or indirect customers (e.g., online or retail customers) to whom manufacturer merchant A 120a may promote the product(s) and/or service(s) of manufacturer merchant B 120b. Such cross-promotions may, for example, take the form of coupon booklets (e.g., attached to manufacturer merchant A 120a's product or product packaging) or direct (e.g., online or offline) promotions.

The manufacturer merchant 120 may act as a recruiting affiliate 105 by recruiting new retail affiliates 111, entity affiliates 112 and/or manufacturer merchants 120 on behalf of the RNA 100. The manufacturer merchant 120 may receive affiliate compensation (such as a flat fee or commission) and/or other promotional benefits in exchange for attracting new affiliates to join the retail network 300.

The manufacturer merchant 120 may manage its own market & offer testing group 124. The testing group 124 may be an organizational unit or team (which may be managed by and/or part of the manufacturer merchant 120) that may be responsible for market analysis, such as marketing, pricing, branding and/or sales performance. The testing group 124 may benefit from services, such as market testing services and showroom optimization services, that may be offered by the RNA 100. In some examples, the RNA 100 may act as a trusted third-party that can facilitate sharing of market information among manufacturer merchants 120 (e.g., enabling sharing of information while maintaining confidentiality and/or competitive secrecy among manufacturer merchants 120).

There may be recruiting affiliates 105, which may be organizations or individuals (including the manufacturer merchant 120, the retail affiliate 111 and the entity affiliate 112, or other entities) that promote the services offered by the RNA 100 to prospective manufacturer merchants, retailers, and consumers. Any signing up of new affiliates resulting from such recruiting activity may result in the recruiting affiliate 105 earning a commission from the RNA 100.

Referrals from retail or entity affiliates 111, 112 may be tracked through the use of unique data or code associated with that affiliate 111, 112. For example, an affiliate 111, 112 may promote a product or service using an affiliate-specific promotional link (e.g., “www.Xspecial.com/RetailerA” or “www.manufacturerX.com/retailerA”) or physical promotional material (e.g., a coupon, a sticker, a brochure, a magazine, a takeaway card, a shelf label or other suitable material) with a URL, coupon code, quick response (QR) code, universal product code (UPC), mobile application, near field communication (NFC) tag or other similar technology that is unique to that affiliate 111, 112. The unique data or code may direct a referred consumer 135 to the manufacturer merchant's website 121 and associate tracking information (e.g., a cookie) with the consumer 135 when the consumer 135 accesses the website 121. In some examples, affiliate-specific promotional links may be generated and managed by the RNA 100, and may be part of a web domain managed by the RNA 100.

In some examples, an affiliate 111, 112 may provide a unique UPC scanning mobile application through which a referred consumer 135 may access an online store. The UPC scanning mobile application may be a software application executed on a mobile device (e.g., a mobile phone, a smartphone, a personal digital assistant or other mobile computing device) that may enable generation (e.g., via scanning a UPC using the mobile device) of a promotional affiliate-specific URL link or electronic communication (e.g., email) that may be used by an entity affiliate 112 or retail affiliate 111 to direct referred consumers 135 to an online store (e.g., the manufacturer's website 121).

The affiliate-specific link or electronic communication may be generated by the RNA 100 and provided to the affiliate 111, 112 through, for example, a secure communication (e.g., secure email or website, or through a specialized software application, such as a mobile app). The affiliate-specific link (or more generally, affiliate-specific data) may be generated by the RNA 100 and tangibly provided to the affiliate 111, 112, for tangible communication (e.g., display in a physical space, in association with the product or service being promoted and/or in association with promotional material) to potential consumers. Consumers may interact with the affiliate-specific link or data, to enable purchase of the product or service. The affiliate-specific link may be data generated by the RNA 100 and outputted to the affiliate 111, 112 (e.g., electronically and/or physically communicated to the affiliate 111, 112).

The affiliate-specific link or electronic communication may be unique to the affiliate 111, 112 providing the mobile application. An affiliate-specific link or electronic communication may have a defined format, such as including the affiliate's identity (e.g., an identification number or name), a product or offer identification (e.g., unique product code) and/or an optional coupon or promotional code. For example, a product code (which may be an alphanumeric string unique to the product and assigned by the manufacturer merchant 120 or the RNA 100) may be combined with an affiliate code (which may be an alphanumeric string unique to the affiliate 111, 112 and assigned by the RNA 100 when the affiliate 111, 112 is first registered with the retail network 300) to generate affiliate-specific data that may be used, for example, as part of an affiliate-specific URL link, QR code or promo code, among other possibilities.

The affiliate-specific data may be communicated to potential consumers in a form that may allow for immediate interaction by the consumers. For example, the affiliate-specific data may be scannable by a mobile device (e.g., a smartphone, camera phone or other mobile computing device) of a consumer, to immediately facilitate a purchase. In some examples, the affiliate-specific data may be stored on a radiofrequency identification (RFID) tag that may be associated with the promoted product or service and/or associated with promotional material. For example, a demo or model of a promoted product may include an RFID tag coded with the affiliate-specific data, and a consumer may scan the RFID tag using a mobile app, to enable online purchase of the promoted product.

In some examples, promotional material (e.g., in-store display) may be identified by a unique code and provided to an affiliate 111, 112. The unique code may be associated with the affiliate and become affiliate-specific data only after the promotional material has been received and accepted by the affiliate 111, 112. This may be the case, for example, where unique codes are printed on packaging of a product (e.g., a demo product), and an affiliate 111, 112 registers the unique code with the RNA 100 after receiving the product, to activate the unique code as affiliate-specific data unique to that affiliate 111, 112

The generated link may include descriptive text, a standard product photo, a product photo captured by the entity affiliate 112, and/or other suitable information. This mobile application may enable an entity affiliate 112 to create affiliate links dynamically, such as while browsing products in a retail store. This may be promoted to an entity affiliate 112 as a “Get Paid to Go Shopping” promotion by the retail affiliate 111, another entity affiliate 112 and/or the RNA 100, for example.

The manufacturer merchant 120 may include one or more servers (not shown) for hosting and/or managing its website 121. Alternatively, the website 121 may be hosted by a server owned by the RNA 100, or another entity (not shown). Any suitable system for hosting and operating an e-commerce website 121 may be used and may not be described in detail in the present disclosure.

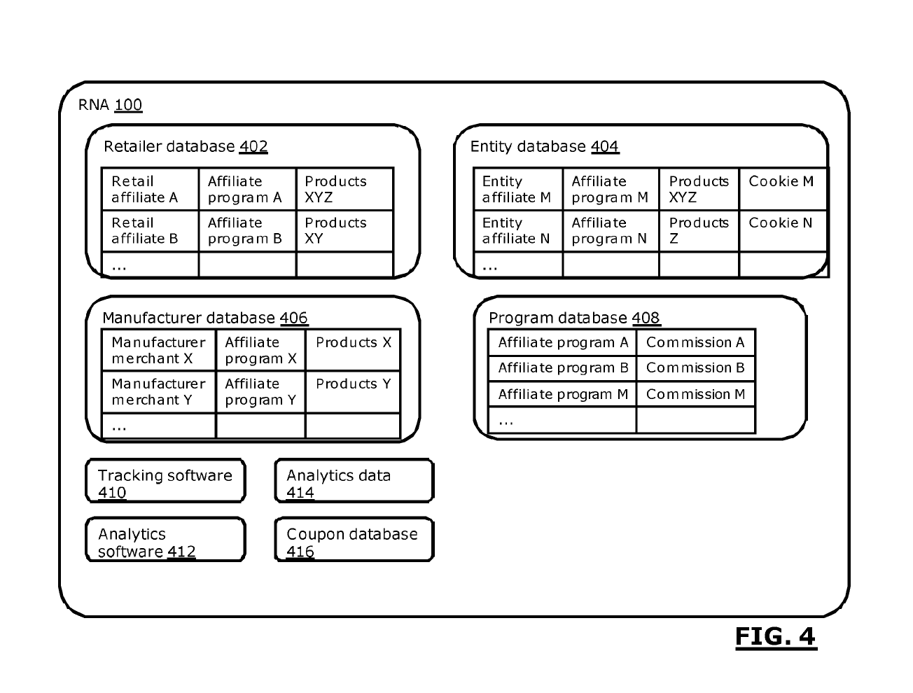

The RNA 100 may include one or more servers. The schematic of FIG. 4 shows the RNA 100 as a single server, however the RNA 100 may operate over two or more servers networked together, for example. The server(s) may be part of a communication network (not shown) (e.g., communicating over a wireless network, such as the Internet, local area network, wide area network, WiFi network and/or other suitable network). The RNA 100 may communicate with affiliates 111, 112 and manufacturer merchants 120 via the communication network, for example through web portals, emails, text messaging, SMS messaging, as well as via physical methods such as physical mail. The server(s) of the RNA 100 may be accessible using any suitable computing device including, for example, desktop computers, other servers, mobile devices and other networks, among others.

The RNA 100 may include (e.g., stored in a memory or other storage on its server(s)) one or more databases, such as retailer database 402, entity database 404, manufacturer database 406, program database 408 and coupon database 416. In some examples, the RNA 100 may not include any such databases, but may have access to such databases (e.g., stored on a secure memory provided by an outside provider).

The retailer database 402 may include information about the retail affiliate(s) 111 in the network 300 (e.g., name, physical location(s) of stores or physical space, product(s) and/or service(s) provided, any affiliate program(s) it is participating in, preferences, and any other suitable details). In some examples, the retailer database 402 may also include WiFi and/or geo-location data related to physical location(s) of the retail affiliate(s) 111, which may be used to enable location-based detection and tracking of referred consumers 135 and entity affiliates 112 that may be referred by the retail affiliate 111, for example as described in the various methods disclosed herein.

The entity database 404 may include information about the entity affiliate(s) 112 in the network 300 (e.g., type of entity, name, product(s) and/or service(s) it is promoting, tracking information such as cookies, any affiliate program(s) it is participating in, preferences, and any other suitable details). In some examples, the entity database 404 may also include information (e.g., tracking information such as cookies, name, product(s) and/or service(s) purchased, and any other suitable details) about non-affiliate entities, such as referred consumers 135 who have not registered as an affiliate.

The manufacturer database 406 may include information about manufacturer merchant(s) 120 in the network 300 (e.g., name, product(s) and/or service(s) produced, any affiliate program(s) it is participating in, and any other suitable details).

The program database 408 may include information (e.g., compensation rates) about any affiliate programs managed by the RNA 100 that are currently active, previously active and/or will be active in the future.

The coupon database 416 may include information about coupons (e.g., product(s) and/or service(s) promoted by the coupon, time over which the coupon is redeemable, and any other suitable details) that are currently active, previously active and/or will be active in the future.

The RNA 100 may update the databases 402, 404, 406, 408, 416 from time to time, for example as entries are added, removed or updated. Other databases may be managed by the ANO 100 for storing and managing other information, as suitable. The example databases 402, 404, 406, 408, 416 shown in FIG. 4 are exemplary only and are simplified for ease of understanding. The RNA 100 may include more databases and more complex databases, are suitable.

The RNA 100 may provide secure, controlled access to some information stored in the databases 402, 404, 406, 408, 416, for example via affiliate portals (e.g., a secure web portal) that an affiliate 111, 112 or manufacturer merchant 120 may access securely (e.g., using a password). The affiliate 111, 112 or manufacturer merchant 120 may be able to set preferences, view information, search for promotional programs, create promotional programs, manage a virtual store and/or receive communications from the RNA 100, for example. Such interactions between the affiliate 111, 112 or manufacturer merchant 120 and the RNA 100 may take place via an affiliate portal, to enable one or more of the example methods described herein.

The RNA 100 may include (e.g., stored in a memory or other storage on its server(s)) one or more software applications which the RNA 100 may use to provide services to the manufacturer merchants 120, the retail affiliates 111 and/or the entity affiliates 112 and/or may make available to be used by the manufacturer merchants 120, the retail affiliates 111 and/or the entity affiliates 112. Such applications may include, for example, tracking software 410 and analytics software 412, among others. In some examples, the RNA 100 may not store such software applications itself, but may access such applications from another provider. The software 410, 412 may be proprietary to the ANO 100 and/or may be any suitable off-the-shelf software.

The RNA 100 may also store (e.g., in a memory or other suitable storage medium) analytics data 414, or other such data. Such data may be gathered using software 410, 412, for example. The data 414 may include historical data, and may be shared with manufacturer merchants 120, retail affiliates 111 and/or entity affiliates 112, for example as described further below.

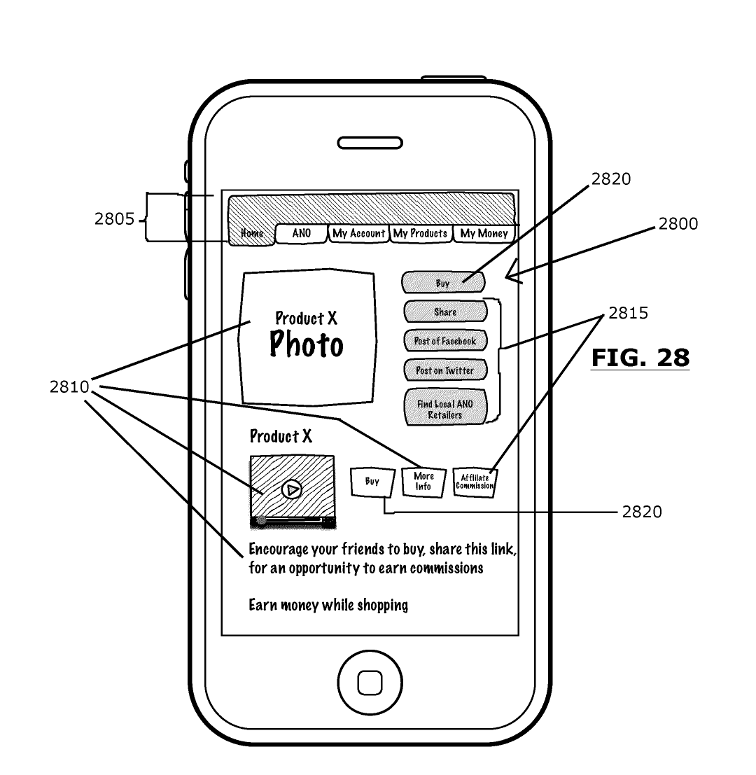

An example of a user interface through which an affiliate 111, 112 or manufacturer merchant 120 may access information managed by the RNA 100 is shown in FIG. 28. FIG. 28 shows an example web portal 2800 for accessing the server(s) of the RNA 100 by an entity affiliate 112. Similar user interfaces may be provided for retail affiliate 111 and manufacturer merchants 120. The web portal 2800 may be accessible via a software application (e.g., a mobile app) provided by the RNA 100, for example. In the example shown, the web portal 2800 may be accessed on the entity affiliate's 112 mobile device (e.g., a smartphone) however the web portal 2800 may be accessed using any suitable computing device having wired or wireless communication capabilities (e.g., desktop computer, personal digital assistant, cellular phone or tablet device).

The web portal 2800 may provide selectable account options 2805 for viewing and/or managing the affiliate's 112 information (e.g., preferences, compensation or credits earned, promotional programs the affiliate 112 has joined and/or products the affiliate 112 has purchased) as tracked by the RNA 100 (e.g., stored in the entity database 404). The affiliate 112 may view information about a particular promotional program via the portal 2800. For example, the affiliate 112 may view information about a particular product being promoted in a promotional program. The entity affiliate 112 may first have to apply to join the promotional program before viewing this information, or this information may be viewable by the entity affiliate 112 prior to joining the promotional program. The portal 2800 may provide product information 2810 (e.g., a static image, a video and text description). The portal 2800 may also include selectable promotion options 2815 to enable the entity affiliate 112 to promote the product. Selection of a promotion option 2815 may cause the generation of an affiliate-specific link by the RNA 100 and the RNA 100 may communicate the generated link to the affiliate's 112 device. The entity affiliate 112 may use the link to promote the product (e.g., by posting on a social media network or by emailing to contacts). The portal 2800 may also include a selectable purchase option 2820, which the entity affiliate 112 may select in order to connect to the manufacturer's website 121 and purchase the promoted product. This purchase may be carried out without the affiliate 112 having to join the promotional program.

In some examples, the portal 2800 or a variation of the portal 2800 may be provided to non-affiliate consumers 130 and referred consumers 135 also. For example, a similar software application provided on a mobile device may be used by consumers 130, 135 to interact with promotional information (e.g., scan product codes, visit manufacturer's websites 121 or receive coupons) and/or make purchases (e.g., including geographical tracking of where the purchase is made).

In some examples, the portal 2800 may also enable social networking by an entity affiliate 112 as well as non-affiliate consumers 130 and referred consumers 135. For example, the portal 2800 may allow the entity affiliate 112 and consumers 130, 135 to participate in a retail social network outside of other social networks (e.g., outside of Facebook or Twitter) and may allow sharing of information (e.g., recommendations, new promotions and reviews) related to the product(s) and/or service(s) promoted in the retail network 300. In some examples, the RNA 100 may track communication over the retail social network and may facilitate payment of compensation to an entity affiliate 112 for promoting product(s) and/or service(s) over the retail social network. For example, an entity affiliate 112 may share photos or reviews of a product with contacts via the retail social network. Such sharing may be tracked by the RNA 100 and the RNA 100 may facilitate compensation to the entity affiliate 112 for each instance of such sharing and/or for each purchase resulting from such sharing, for example as described in the various methods of the present disclosure. Use of a dedicated retail social network to communicate promotional information may be preferable to communication over conventional social networks, since an entity affiliate's 112 contacts on a dedicated retail social network may be specifically selected by the entity affiliate 112 as contacts who are known to be interested in promotions. Use of a dedicated retail social network may also allow for partitioning of the affiliate's 112 and consumer's 130, 135 personal life from interactions with the retail network 300. The RNA 100 may also have greater oversight over communications in the retail social network than in conventional social networks.

The server(s) of the RNA 100 may communicate with one or more computing systems of the other entities in the retail network 300, including computing systems (e.g., servers, desktop computers or mobile devices) of affiliates 111, 112, manufacturer merchants 120 and/or consumers 130, 135, in order to transmit and receive electronic data to carry out retail transactions (e.g., for ecommerce).

Some example methods for retailing and managing retail relationships are described below, with respect to the example system of FIGS. 3 and 4. In the examples described, the RNA 100 may act as a central manager of the retail affiliate network 300. Generally, the affiliate network 300 may be managed by a single RNA 100.

In some examples, the RNA 100 may also act as a manufacturer merchant 120 or a retail affiliate 111 (e.g., the RNA 100 may also be a producer or provider of product(s) and/or service(s), in addition to performing its role as RNA 100).

For example, a single manufacturer merchant 120 may act as the RNA 100 and the retail network 300 may include retail affiliates 111 and/or entity affiliates 112 having retail relationships with the single manufacturer merchant 120 acting as the RNA 100. The manufacturer merchant 120, in its role as the RNA 100, may carry out any and all of the functions of the RNA 100, as described herein. The manufacturer merchant 120 may create its own promotional program, may provide its own promotional material to the affiliates 111, 112 and may track purchases of its products and/or services resulting from referrals by the affiliates 111, 112. The manufacturer merchant 120 may compensate the affiliates 111, 112 for customer referrals.

In another example, a single retail affiliate 111 may act as the RNA 100 and the retail network 300 may include manufacturer merchants 120 and entity affiliates 112 having retail relationships with the single retail affiliate 111 acting as the RNA 100. The retail affiliate 111, in its role as the RNA 100, may carry out any and all of the functions of the RNA 100, as described herein. The retail affiliate 111 may act as a RNA 100 that manages its own retail stores, for example. The retail affiliate 111 may create promotional programs for products and/or services from manufacturer merchants 120 that are retailed in its retail stores, may provide its own promotional material to affiliates 112, and may track purchases of products and/or services from manufacturer merchants 120 resulting from referrals by affiliates 112. The retail affiliate 111 may compensate entity affiliates 112 for customer referrals.

For ease of understanding, the present disclosure may refer to the RNA 100 as a third-party managing relationships between manufacturer merchants 120 and affiliates 111, 112. However, in some examples the RNA 100 may be a particular single manufacturer merchant 120 managing relationships with its affiliates 111, 112; or the RNA 100 may be a single retail affiliate 111 managing relationships with its manufacturer merchants 120 and entity affiliates 112.

In general, after joining the affiliate network 300, a manufacturer merchant 120 may implement one or more promotional programs through retail affiliates 111 and/or entity affiliates 120, across the entire retail network 300 or in subsets of the network (e.g., by region, store type, or market).

Each manufacturer merchant 120 may be associated with an affiliate program (which may be stored in the manufacturer database 406 of the RNA 100, as described above), which may specify a certain commission (e.g., percentage of revenue) for each product, service and/or category of goods and/or services to be sold through the retail network 300. For example, the program may specify what commissions may be earned by retail affiliates 111 for direct referrals (e.g., sales made to consumers 130 who visited a retail location), commission earned by entity affiliates 112 from referred sales (e.g., due to the entity affiliate 112 promoting a product to the referred consumer 135), as well as commission earned by the retail affiliate 111 for indirect referrals (e.g., where a referred sale results from a referral by an entity affiliate 120 who originally was informed of a promotion through the retail affiliate 111). The affiliate program (e.g., specific financial terms) may be negotiated between the manufacturer merchant 120 and the RNA 100, for example depending on the manufacturer's product category, business profile, and/or return policies.

Direct transactions between a consumer 112, 135 and the manufacturer merchant 120 may be through the manufacturer's e-commerce website 121. Tracking software 410 from the RNA 100 may be used to track activity on the manufacturer's website 121 and attribute the activity to the appropriate referring party, for example:
A referred consumer 135 accessing the manufacturer's website 121 as a result of a referral from a retail affiliate 111 or an entity affiliate 112. This referral may be tracked when the referred consumer 135 accesses the manufacturer's website 121 using unique affiliate-specific data (e.g., a promotional link or coupon code unique to the specific referring affiliate 111, 112). For example, the referred consumer 135 may access the manufacturer's website 121 (e.g., at home or on the consumer's 135 mobile device) after being presented with promotional material by the affiliate 111, 112. In some examples, where the referred consumer 135 is provided with promotional material at a retail store of a retail affiliate 111, the retail affiliate 111 may assist the referred consumer 135 with accessing the website 121 (e.g., the consumer 135 may bring a promotion coupon to a clerk in the retail store, and the clerk may help the consumer 135 to access and/or complete a purchase on the website 121).
Completion of a target action (e.g., a purchase of a product or service) by the referred consumer 135 on the manufacturer's e-commerce website 121, may be attributed to a referring affiliate 111, 112 even at a future time (e.g., later in the day or even several months later). For example, when a referred consumer 135 first visits the manufacturer's website 121 using unique affiliate-specific data (e.g., a promotional link or coupon code unique to the specific referring affiliate 111, 112), even if no further action is taken by the referred consumer 135, tracking information (e.g., cookie) may be attached to that referred consumer 135 to identify the referred consumer 135 as having been referred by a specific affiliate 111, 112. When the referred consumer 135 returns to the manufacturer's website 121 at a future time and complete a target action, the tracking information attached to the referred consumer 135 may enable the RNA 100 to attribute completion of the target action to the original referring affiliate 111, 112.

Affiliate policies may also apply to commission earned by retail affiliates 111 and/or entity affiliates 112. For example, policies (which may be subject to terms and conditions specified by the RNA 100 and/or a relevant manufacturer merchant 120) may define commissions earned for actions completed by direct and indirect referrals by the affiliate 111, 112.

A specific example of retail using the disclosed retail network 300 is provided below. More general example methods are described further below.

The manufacturer merchant 120 may run a retail affiliate recruiting campaign via the RNA 100 and sign up 30 new retail affiliates 111 from any country.

The manufacturer merchant 120 may arrange, via the RNA 100, a relationship with a retail affiliate 111 such as Sports R Us, an independent retailer of sports equipment with an existing website www.Retailer.com and a mailing list of 2,000 customers.

The manufacturer merchant 120 may provide a display unit to Sports R Us that is part of a bicycle promotion, a demo of the product, optional DVD/video, and a dispenser of promotional stickers. The promotional stickers may include a unique affiliate-specific QR code on the sticker, and instructions and a web link on the back “peel away” paper of the sticker. The web link and QR code may direct a consumer to a unique URL that is linked to www.Retailer.com and may be used by a consumer who signs up as an entity affiliate 112. The unique URL may be unique to the entity affiliate 112 and may be used as a “refer a friend” link, through which the affiliate's 112 contacts may order the product online.

When selling any regular in-store purchase, the retail affiliate 111 may attach a promotional QR code sticker to the customer's receipt (e.g., promoting the bicycle with QR Code). The retail affiliate may be profiled on the manufacturer merchant's website 121 as a participating retailer, and may have an affiliate-specific link such as www.RetailSpecials.com/RetailerX, www.BikeContest.com/RetailerX, or www.ProductXSpecial.com/Retailer, for example. The web domain of the affiliate-specific link may be a domain that is managed by the RNA 100 (and that may be hosted on the RNA's 100 server(s))

Consumers in the retail store may be encouraged to buy the bicycle online while they are in the store (e.g., using computing devices provided by Sports R Us), for which Sports R Us may receive a fixed commission (e.g., 15% commission). Referred consumer 135 may also order the bicycle online (e.g., from home), using the QR Code provided on the promotional material, for which the consumer 135 may receive a slight discount (e.g., $10 off the online price), and for which Sports R Us may receive a fixed commission (e.g., 7.5% of the product revenue). The consumer 135 ordering online may be able to choose direct shipment to their home or to arrange for in-store pickup at Sports R Us.

If ordering in the retail store, a referred consumer 135 may bring the promotional material with the QR code to a store clerk. The clerk may visit the manufacturer's website 121 via the affiliate-specific link (e.g., www.Manufacturer.com/Retailer) and enter the consumer's 135 order details directly on behalf of the consumer 135, including arranging for delivery to the consumer's 135 address.

Sports R Us may also promote the bicycle to its mailing list of 2,000 consumers (e.g., via promotional material including the affiliate-specific link, which may be provided by email, or QR code and URL, which may be provided by direct mail), and any purchases resulting from that email promotion may be attributed to Sports R Us. Sports R Us may receive a fixed commission (e.g., 7.5% commission on product revenue). Generally, commission rates may not apply to HST or shipping costs.

After a referred consumer 135 makes an order, the consumer 135 may be notified by the manufacturer merchant 120 directly (e.g., by email) (with a copy sent to the retail affiliate 111) of order information such as a customer receipt, shipping notification and delivery notification.

The consumer 135 may be encouraged to participate as an entity affiliate 112 in the “refer-a-friend” program in various ways.

The consumer 135 may have received promotional material while in-store (e.g., through a self-serve QR code sticker dispenser or as an attachment or insert along with purchase of any in-store items). As described above, the promotional material may contain a unique QR code and web link, along with instructions, that encourage the consumer 135 to place the unique code and link in a public place that will generate online visitors. The consumer 135 may also be instructed to scan the QR code or visit the web link and sign up for the “refer a friend” promotional program. Upon signing up for as an entity affiliate 112 and joining the promotional program, the entity affiliate 112 may be encouraged to start a unique online webpage with a personalized URL such as www.MyVirtualStore.com/JaneSmith or http://Special.Manufacturer.com/JaneSmith. The entity affiliate 112 may personalize the webpage, for example by writing a description or submitting a video explaining why they support the product. The entity affiliate 112 may promote the personalized webpage to friends and contacts through various suitable online methods (e.g., email, Facebook, Twitter, and other social methods) and offline methods (e.g., promotional material, which may be provided via the RNA 100, listing the webpage link).

Any purchase by a referred consumer 135 who buys the promoted product through the entity affiliate's 112 unique link may be attributed to both the entity affiliate 112 as well as the retail affiliate 111 that first recruited the active entity affiliate 112.

If the referred consumer 135 purchases the product and has not signed up as an entity affiliate 112 already, then the manufacturer merchant 120 may promote the refer-a-friend program to the consumer 135 following the purchase (e.g., 10 to 30 days after purchase). The consumer 135 may be incented with a reward (e.g., $25 gas card, charitable donation, other gift, or cash offer) for each referred contact that purchases the promoted product. Compensation may be earned for purchases by referrals, as described above.

Commission earned by the retail affiliate 111 may only apply to direct referrals made by entity affiliates 112 who were directly recruited by the retail affiliate 111. If a Sports R Us customer (e.g., Jane Smith) refers a friend (e.g., Lisa Jones), and Lisa refers another friend (e.g., Jennifer Sheard) who purchases the product, then Lisa may get a referral compensation, however neither Sports R Us nor Jane Smith may get any compensation. In other examples, there may be multiple tiers of compensation, such that Jane Smith may also get compensation, or both Sports R Us and Jane Smith may get compensation. Depending on how the promotional program is defined, compensation amounts may decrease for each additional tier of referral—that is, in the example described above, Lisa may get more compensation than Jane who may in turn get more compensation than Sports R Us.

Although in the example above the entity affiliate 112 was recruited by a retail affiliate 111, in some examples, the entity affiliate 112 may be recruited by another entity affiliate 112 (in place of or in addition to the retail affiliate 111 as described above), in which case that other entity affiliate 112 may also be compensated for purchases made by the referred consumer 135.

Referrals may be identified and tracked using tracking information such as IP addresses or web browser “cookies”, which may a duration of at least 6 months before expiry. For example, after visiting www.Manufacturer.com/Retailer, the visitor may be tagged with a web browser cookie that associates the visitor with the retail affiliate 111. If the visitor revisits www.Manufacturer.com a month later using the same web browser (and the cookie is still active or the IP address is the same), then the visitor may be associated with the retail affiliate 111 and the retail affiliate 111 may earn a commission on any purchases made during that visit.

Compensation may be earned in relation to product revenue, excluding sales tax and shipping fees. The manufacturer merchant 120 may independently offer special discounts and promotions to encourage sales. Such offers may apply to referred purchases also, which may result in higher total revenue (and total compensation earned by affiliates 111, 112) but lower product revenue (and compensation) per sale.

Affiliates 111, 112 may have a web-based, self-serve portal through which they may manage their affiliate commission earnings and payments.

In the event of a product refund, the manufacturer merchant 120 may cancel the related affiliate compensation and deduct the cancelled amount from future compensation payments. At its discretion, the manufacturer merchant 120 may delay payment of affiliate compensation based on refund periods, affiliate history, and/or sales volume, for example.

It may be preferable for the manufacturer merchant 120 to have sales through its website 121, in order to establish a direct relationship between the manufacturer merchant 120 and the consumer.

The present disclosure may enable promotion and sale of products and services among merchant manufacturers 120, consumers 112, 130, 135, and retail affiliates 111 in a variety of ways. Some further examples are described below.

### Example Method for Adding a Manufacturer Merchant

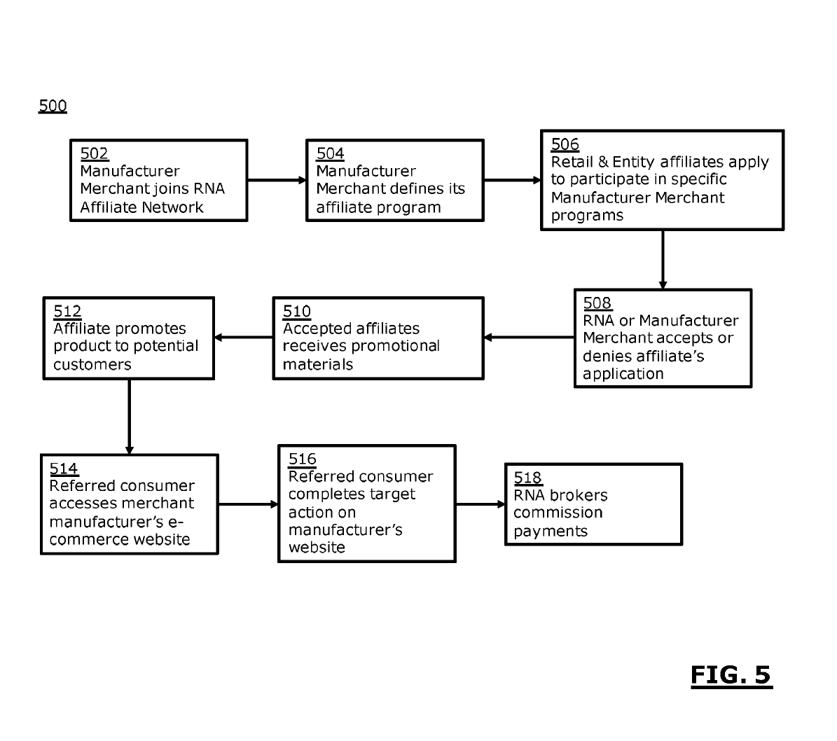

FIG. 5 is a flowchart illustrating an example method 500 for adding a manufacturer merchant 120, which method may be carried out by the example system of FIGS. 3 and 4.

At 502 a manufacturer merchant 120 may join the affiliate network 300. For example, the manufacturer merchant 120 may apply to the RNA 100 to join the network 300. The RNA 100 may accept the application (e.g., depending on whether or not the applicant meets certain criteria, such as target market, reputation and revenue). Acceptance of the application may require the manufacturer merchant 120 to sign an agreement with the RNA 100. The manufacturer merchant 120 may be required to make a deposit to the RNA 100, to be held in trust for future commission payouts. In some examples, such as where the manufacturer merchant 120 has proof of steady revenue, the RNA 100 may not require such a deposit from the manufacturer merchant 120.

After the manufacturer merchant 120 has been accepted into the retail network 300 by the RNA 100, the manufacturer merchant 120 may be registered into the manufacturer database 406. Information about the manufacturer merchant 120 (e.g., name, location and products manufactured, as provided in the application) may be stored in the manufacturer database 406 and associated with the newly registered manufacturer merchant 120. The RNA 100 may generate a unique manufacturer identification code (which code may be an algorithmically- or randomly-generated code) for the manufacturer merchant 120 and record such information in the manufacturer database 406.

Prior to or as part of the method 500, a retail affiliate 111 or an entity affiliate 112 may join the retail network 300 by applying to the RNA 100 in a manner similar to that described above. After the new affiliate 111, 112 has been accepted by the RNA 100, the new affiliate 111, 112 may be registered into the appropriate retail database 402 or entity database 404 with a unique identification code.

At 504, the manufacturer merchant 120 may define its affiliate program. The affiliate program may be defined through negotiations with the RNA 100. In some examples, no negotiations may be required, such as where the RNA 100 has a predefined fee structure (e.g., X % commission is paid to the retail affiliate 111 for each sale, and for every $1 of commission earned, the RNA 100 charges an additional Y % to the manufacturer merchant 120 as a broker fee). The affiliate program may define, for example, one or more promotional programs for retail affiliates 111 and/or entity affiliates 112, the product(s) and/or service(s) promoted (e.g., specific products and/or services, certain product categories, or the entire inventory), and associated commission structure. Throughout the present disclosure, the term “product” may be used as shorthand for product and/or service. It should be understood that a product may be a physical or virtual product, and similarly a service may be a physical or virtual service, for example.

In some examples, 504 may be performed together with 502. That is, part of the process for the manufacturer merchant 120 being accepted into the retail network 300 by the RNA 100 may be a negotiation and definition of the affiliate program for the manufacturer merchant 120. The manufacturer merchant 120 may have the option of modifying its affiliate program at a later time (e.g., through further negotiation with the RNA 100). The RNA 100 may assist the manufacturer merchant 120 with development of its promotional program (e.g., by providing access to analytics data 414 stored by the RNA 100).

The merchant manufacturers 120 may then be a listed merchant that may be identified and/or searchable to the retail & entity affiliate network 110. Retail affiliates 111 and/or entity affiliates 112 may then be able to apply to participate in the promotional program(s) defined by the merchant manufacturer 120.

At 506, one or more retail affiliates 111 and/or entity affiliates 112 may apply to participate in one or more specific promotional programs from the manufacturer merchant 120. The retail affiliates 111 and/or entity affiliates 112 may be able to browse, search, select and/or apply to a promotional program through the RNA 100. For example, the program database 408 managed by the RNA 100 may be accessible and searchable (e.g., by product type, location and/or merchant) by retail affiliates 111 and/or entity affiliates 112 (e.g., through secure online portals or other methods of online or offline communication) and/or the RNA 100 may communicate to retail affiliates 111 and/or entity affiliates 112 the addition of new promotional programs (e.g., through electronic communication, such as email). A retail affiliate 111 or entity affiliate 112 may have the option of setting a profile that defines the type(s) of promotional programs it wishes to be informed of.

In some examples, an affiliate 111, 112 may be invited by the manufacturer merchant 120 to join a promotional program. For example, a consumer 130, 135 who is not yet an affiliate may be invited (e.g., via follow up email or mail communications) by the manufacturer merchant 120 to become an entity affiliate 112 and join the manufacturer merchant's 120 promotional program, after the consumer 130, 135 purchases a product and/or service from the manufacturer merchant 120. In some examples, after the consumer 130, 135 purchases the product and/or service from the manufacturer's website 121 (e.g., via the Internet) or during the process of purchasing the product and/or service from the website 121, the consumer 130, 135 may be presented with a promotion or invitation to join the retail network 300 as an entity affiliate 112 (e.g., in exchange for a promotion or reward, such as free shipping or an immediate discount on the purchase). For example, the consumer 130, 135 may be presented with a user interface including a selectable one-click or one-touch option or a selectable accept/reject option to join the retail network 300. In some examples, the consumer 130, 135 may be presented with a user interface including fillable fields for providing consumer information (e.g., name, address and telephone number) to the RNA 100, and one or more fields may be pre-populated (e.g., using information provided by the consumer 130, 135 during the purchase process). The consumer 130, 135 may be required to accept a policy or privacy agreement (which may be displayed on the same or different user interface as the selectable option to join the retail network 300) prior to accepting the option to join the retail network 300.

At 508, the RNA 100 and/or the manufacturer merchant 120 accepts or denies the application from the affiliate 111, 112. This may be based on, for example, whether the applicant affiliate 111, 112 satisfies certain criteria (e.g., age, income or target market) defined in the promotional program. In some examples, the RNA 100 alone may determine whether to accept or deny the application from the affiliate 111, 112, based on criteria defined by the manufacturer merchant 120 in its promotional program. Where the promotional program has defined a promotion or reward to be offered to the affiliate 111, 112 upon joining the promotional program, the RNA 100 may manage crediting and/or delivery of the promotion or reward to the affiliate 111, 112 after the affiliate 111, 112 has been accepted into the promotional program. The RNA 100 may thus serve as a trusted third-party broker between the manufacturer merchant 120 and the affiliate 111, 112. As well, this may free the manufacturer merchant 120 from having to deal with the details of promoting a product that the manufacturer merchant 120 may not be familiar with nor have the resources to handle.

Where the affiliate 111, 112 is a newly recruited affiliate 111, 112 (e.g., where a consumer 130, 135 is responding to an invitation on the manufacturer's website 121 to join the retail network 300), the RNA 100 may register the new affiliate 111, 112 and generate a unique identification code for the affiliate 111, 112 (e.g., as described above) as part of accepting the affiliate 111, 112 into the promotional program.

At 510, affiliate(s) 111, 112 accepted into a given promotional program may receive promotional materials (e.g., in-store display, sample product, affiliate-specific tracking data (such as affiliate-specific promotional links, coupons and/or QR codes) and/or other materials or information for store and online promotions). Promotional material may originate from the manufacturer merchant 120 (e.g., where the manufacturer merchant 120 designs and creates its own promotional material) and/or from the RNA 100 (e.g., where the manufacturer merchant 120 chooses to rely on the resources of the RNA 100). Such material may be provided to the affiliate(s) 111, 112 by the RNA 100 through electronic communication (e.g., email providing an affiliate-specific link) or offline communication (e.g., shipping a physical store display to a retail affiliate 111). In some examples, the promotional material may include a representative display or a representation of a vendible product, such as a physical demo product, a sample produce, a model of the product and/or an electronic display (e.g., a 3D hologram or a screen image) of the product. In the case of an electronic display, the data for generating the electronic display may be transmitted by the RNA 100 (e.g., from its server(s)) to a computer system of the affiliate 111, 112. Such electronic data may be re-transmitted by the affiliate 111, 112 to computing devices (e.g., cellular telephone, smartphones, tablet devices and other mobile computing devices) of consumers 112, 130, 135 and/or may be used by the affiliate 111, 112 to generate the electronic display (e.g., on an appropriate output device such as a computer or television screen, or a holographic device).

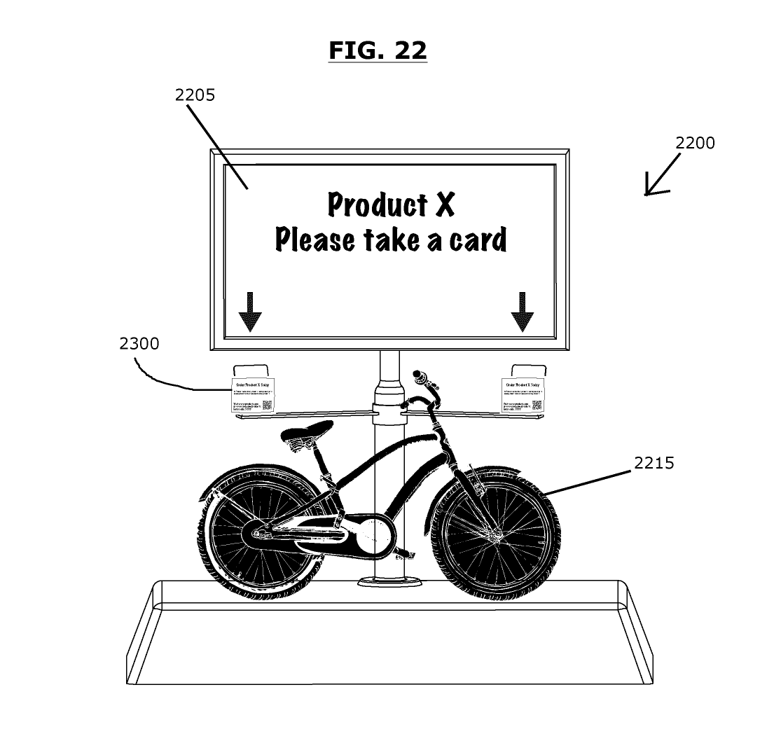

FIG. 22 is a diagram of an example in-store display 2200, which the RNA 100 may provide to a retail affiliate 111 to promote a manufacturer's 120 product. The in-store display 2200 may include a display panel 2205, which may be an electronic display (e.g., a flat screen TV or touch screen display) or a non-electronic display (e.g., a poster). The in-store display 2200 may also include a physical demo product 2215, and may provide purchase tokens, such as coupons, electronic purchase information (which may be transmitted to computing devices of consumers 112, 130, 135 via near fear communication, for example) and/or promotional cards 2300. The purchase token may provide information about the product and/or service being promoted, as well as information, such as an affiliate-specific link or code, to enable consumers 112, 130, 135 to purchase the promoted product and enable the RNA 100 to track the purchase as stemming from a referral by the retail affiliate 111. As described further below, the in-store display 2200 may be created by the manufacturer merchant 120 and/or the RNA 100, and may be provided (e.g., via physical and/or electronic delivery, as appropriate) to the retail affiliate 111 via the RNA 100.

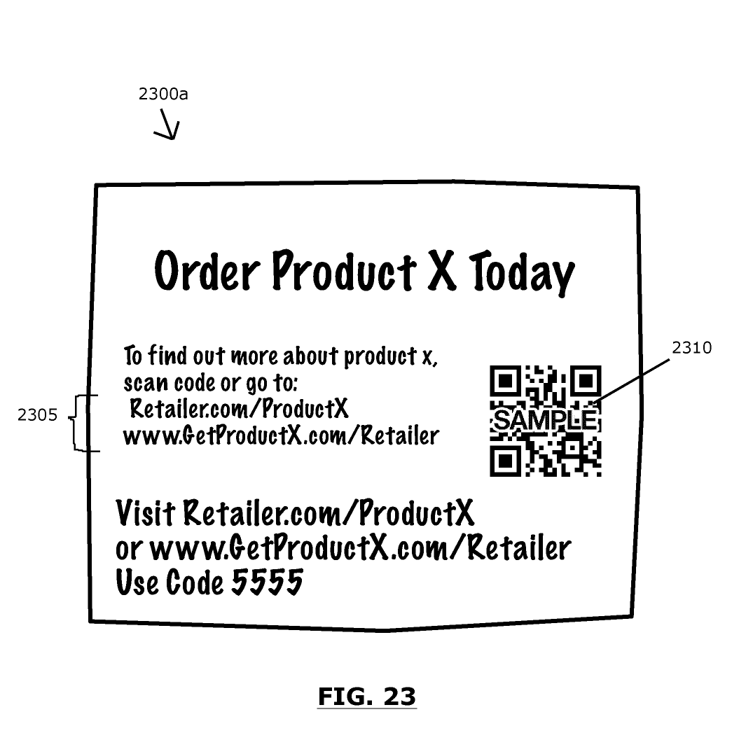

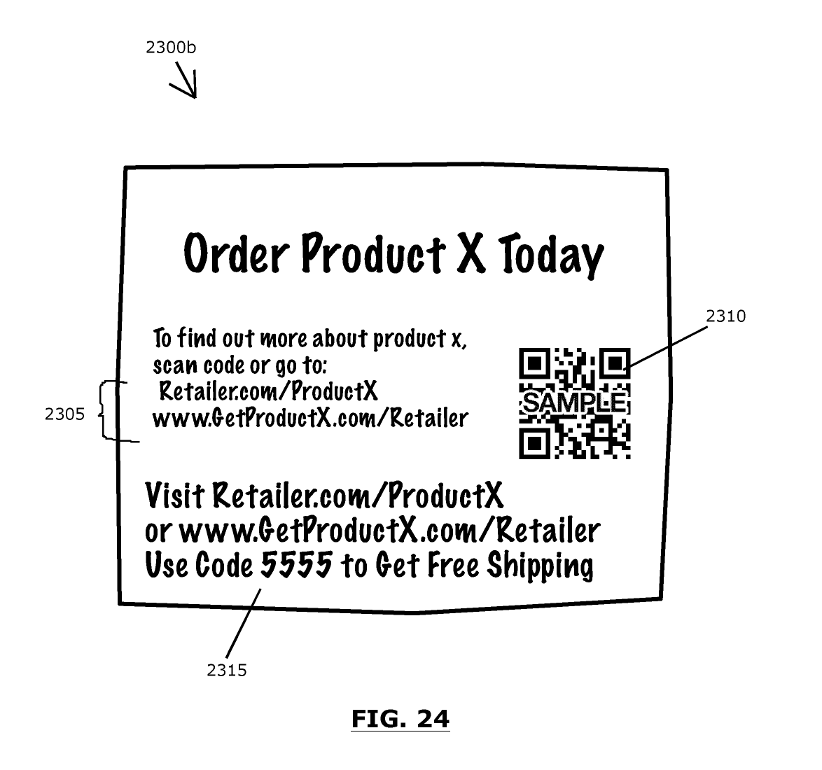

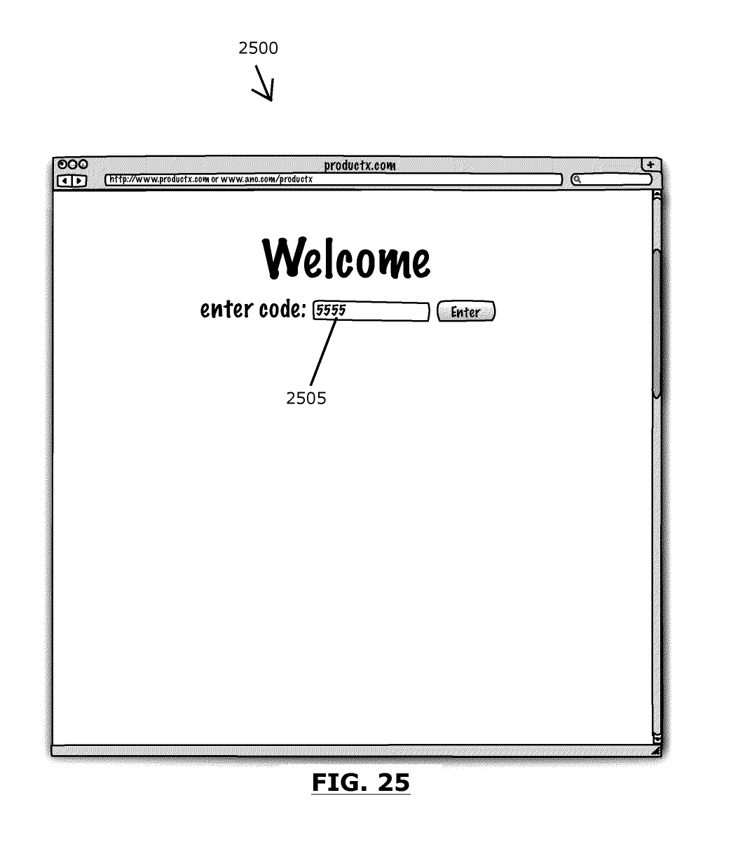

FIGS. 23 and 24 show examples of promotional cards 2300a, 2300b. The promotional card 2300a, 2300b may include an affiliate-specific link 2305 and/or an affiliate-specific QR code 2310 that a consumer 112, 130, 135 may use to access the manufacturer's website 121 (e.g., via a computer or a smartphone) while being tracked by the RNA 100 as resulting from a referral by the retail affiliate 111. In the example of FIG. 24, the promotional card 2300b may also provide a promotional code 2315 that a consumer 112, 130, 135 may enter into the manufacturer's website 121 in order to redeem a promotion. For example, FIG. 25 shows a user interface 2500 that the consumer 112, 130, 135 may be presented with when accessing the manufacturer's website 121 (e.g., via an affiliate-specific link or QR code). The user interface 2500 may include a text box 2505 for entering a promotional code 2315, for example.

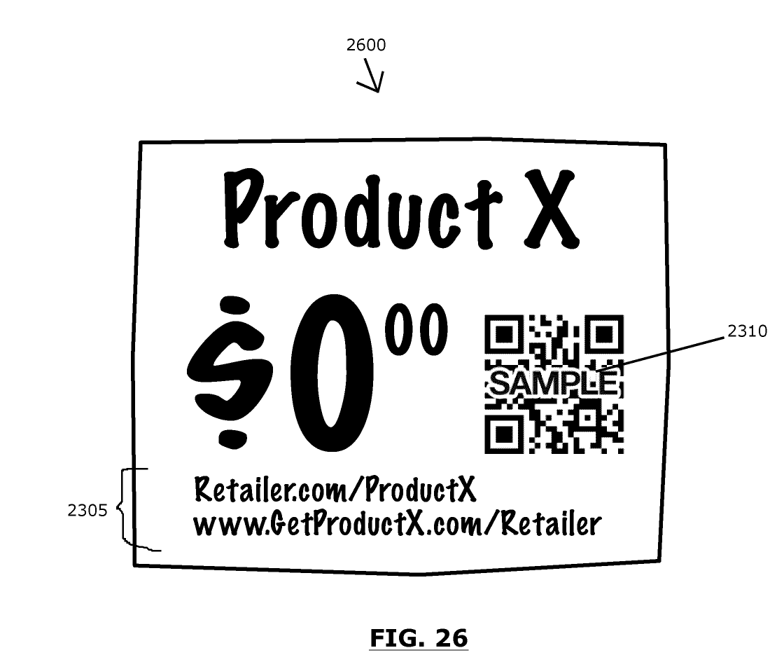

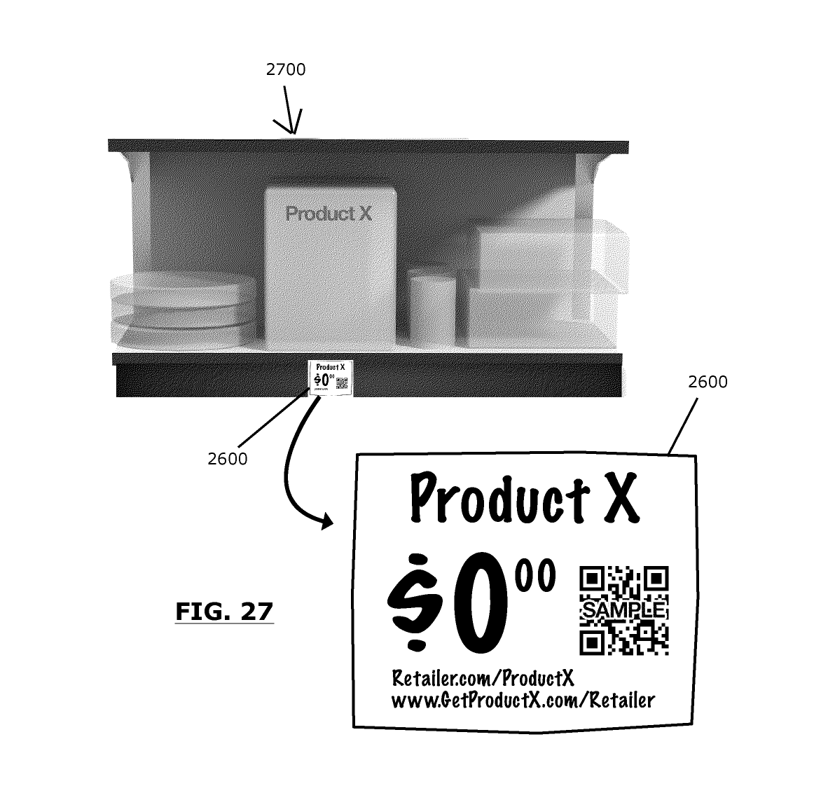

FIG. 26 shows an example shelf label 2600, that a retail affiliate 111 may place on a product shelf near the promoted product (see FIG. 27, for example, showing positioning of an example shelf label 2600 on a product shelf 2700). The shelf label 2600 may include an affiliate-specific link 2305 and/or an affiliate-specific QR code 2310, as described above.

At 512, the affiliate(s) 111, 112 uses the promotional material to promote the product(s) and/or service(s) of the manufacturer merchant 120 to potential customers. For example, a retail affiliate 111 may use an in-store display to promote the product(s) and/or service(s) to in-store visitors. An online entity affiliate 112 may use an affiliate-specific link to promote the product(s) and/or service(s) to online contacts.

At 514, a referred consumer 135 may access the merchant manufacturer's ecommerce website 121 using affiliate-specific data (e.g., via an affiliate-specific link or code). This access may be tracked by the RNA 100 using suitable tracking software 410 (e.g., through creation of a cookie for the referred consumer 135). The RNA 100 may also track the source of the referral, based on the affiliate-specific data used by the referred consumer 135. The referred consumer 135 may be directed to the manufacturer merchant's e-commerce website 121.

At 516, the referred consumer 135 may complete a target action (e.g., a transaction) on the manufacturer's website 121. The completion of the target action may be tracked by the RNA 100 using suitable tracking software. The RNA 100 may use tracking information to attribute the completion of the target action to the appropriate referring affiliate(s) 111, 112.

At 518, the RNA 100 may broker commission payments (e.g., percentage of sales or CPA payments) from the manufacturer merchant 120 to the referring affiliate(s) 111, 112. The RNA 100 may calculate the appropriate commission based on tracking information gathered by the RNA 100. The RNA 100 may inform the manufacturer merchant 120 of the commission to be paid. The RNA 100 may bill the manufacturer merchant 120 for the commission payment or may deduct the commission payment from moneys held in trust. The RNA 100 may provide commission payments to the affiliate(s) 111, 112 in any suitable means including, for example, direct deposit into an account or mailing of a cheque. Commission payments may be made after each successful transaction, at defined time intervals (e.g., monthly or weekly) or at defined payment levels (e.g., every $100 earned), for example.

Compensation that may be earned by a retail affiliate 111 may include, for example:
a percentage commission on ecommerce revenue (e.g., resulting from purchases by consumers directly from the manufacturer merchant 120) resulting from promotions provided by the retail affiliate 111 (e.g., with an option to exclude returns)
a percentage commission on revenue generated by an entity affiliate who received the promotional material through the retail affiliate (e.g., through a store visit)
a flat fee per retail store visitor (e.g., payment for product exposure based on store traffic, which may include an option to set a maximum budget for exposure). Retail traffic may be tracked using traffic monitoring technology provided by the RNA 100, for example.
a flat fee per retail store visitor who visits the manufacturer's website 121 (which may include an option to set a maximum budget for website visitors)
a flat fee per retail store (e.g., based on display size, duration, and/or estimated store traffic)

RNA 100 may act as a trusted third-party to broker the relationship and transactions between manufacturer merchants 120 and affiliates 111, 112.

The RNA 100 may be a third-party that is trusted by the manufacturer merchant 120 and the affiliate 111, 112, and may facilitate transactions between the manufacturer merchant 120 and the affiliate 111, 112 by providing a level of security and assurance against breach of agreement or defaults by the manufacturer merchant 120 and/or the affiliate 111, 112, throughout the method 500, as well as throughout other transactions in the retail network 300 (e.g., as described in the present disclosure).

In some examples, promotional information provided to the affiliate 111, 112 may include electronic data, which the affiliate 111, 112 may share electronically (e.g., via email or social networks) with contacts. In some examples, the manufacturer merchant 120 and/or the RNA 100 may publish an electronic data feed of products and/or services available for promotion. This data feed may be specific to the manufacturer merchant 120 and/or may be specific to a category of products and/or services, for example. An affiliate 111, 112 may subscribe to the data feed, in order to receive up-to-date information on promotions, and may share information from the data feed with contacts.

### Example Method for Managing Retail Promotions

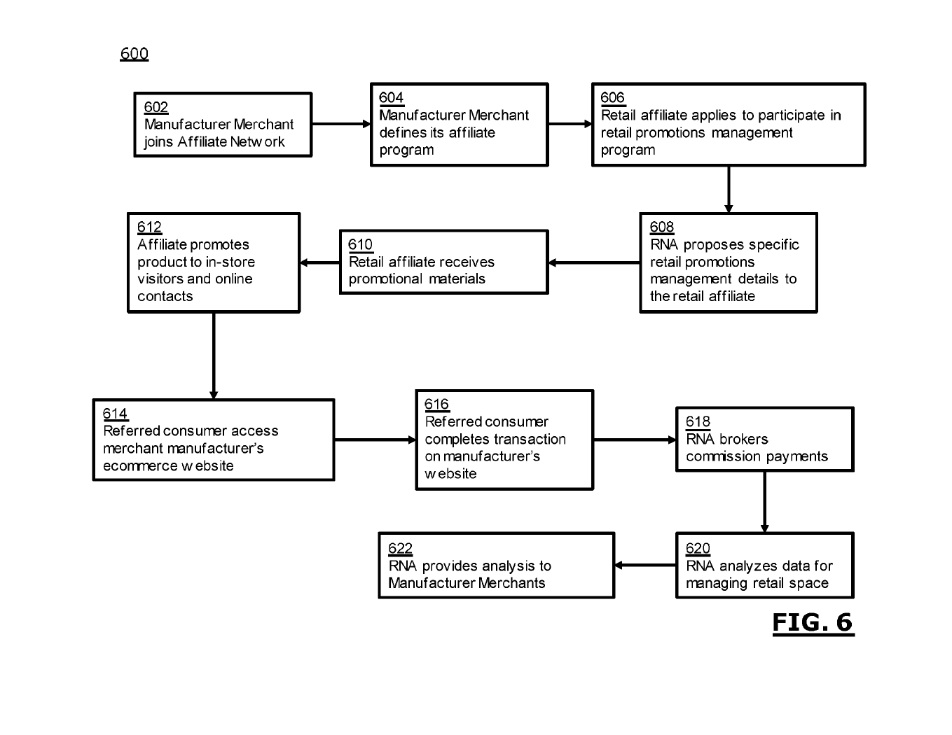

FIG. 6 is a flowchart illustrating an example method 600 for managing retail promotions, which method may be carried out by the example system of FIGS. 3 and 4.

At 602, the manufacturer merchant 120 may join the affiliate network 300, for example as described in or similar to that described in the various methods disclosed herein.

At 604, the manufacturer merchant 120 may define its affiliate program, for example as described in or similar to that described in the various methods disclosed herein. The program may include participation in a program for managing retail promotions (which may also be referred to as “showroom optimization”), which program may be managed by the RNA 100.

At 606, a retail affiliate 111 may apply to participate in the program for managing retail promotions. The retail affiliate 111 may apply to the RNA 100 and be accepted into the program, similar to the application process described in method 500. Criteria used to determine whether or not to accept the retail affiliate 111 into the retail promotions management program may include, for example, the type and size (e.g., square footage) of the retail space, the type and size customer traffic in the space and/or the products and services the retail affiliate 111 is interested in promoting.

At 608, the RNA 100 may propose specific details of retail promotions management to the retail affiliate 111. Details of retail promotions management may include, for example, an in-store display schedule and/or electronic promotion package, including terms of compensation. The proposed retail promotions management details may be based on previous analytics data 414 and/or historical data gathered by the RNA 100 from previous instances of the retail management program, for example. The promotional material provided to the retail affiliate 111 may be designed to promote product(s) and/or service(s) from one or more manufacturer merchants 120 to potential customers in the retail space of the retail affiliate 111. Examples of promotional material are described elsewhere in the present disclosure.

At 610, after the retail affiliate 111 accepts the proposed details of retail promotions management, the retail affiliate 111 may receive promotional materials from the RNA 100. Such promotional materials may include, for example, in-store displays, demo product(s), electronic signage, display content, retail display holograms, affiliate-specific promotional data, coupons, QR codes, and/or other materials intended for in-store and online promotions.

Example in-store displays may include electronic displays (e.g., displaying posters), physical coupon dispensers, and computers with user input controls (e.g., keyboard and/or touch screen). In-store displays may have access to power, and may have network connectivity (e.g., wireless connectivity through local WIFI or other wireless data connection). A demo product or mock-up may be displayed as part of the in-store display (e.g., below a promotional poster), for example as shown in and described with reference to FIG. 22.

In lieu of a physical demo product, the in-store display may use electronic displays, such as a holographic display, which may provide a better understanding of the product's nature and/or its inner workings. The RNA 100 may invest in and maintain such promotional technology at little or no cost to the manufacturer merchant 120 and/or retail affiliate 111. In this way, the RNA 100 may provide the manufacturer merchant 120 and/or retail affiliate 111 a way to take advantage of more sophisticated promotional techniques and/or technology with little or no financial risk, which may help the manufacturer merchant 120 and/or retail affiliate 111 (which may have limited resources) to better compete with mass merchandisers 14 (which typically have vast resources).

At 612, the retail affiliate 111 may promote product(s) and/or service(s) of the manufacturer merchant(s) 120 using the promotional material. Entity affiliates 112 may also, through visiting the retail store, obtain promotional material (e.g., affiliate-specific links, coupons, and QR codes, among others) to promote product(s) and/or service(s) to online or offline contacts.

At 614, a referred consumer 135 may access the merchant manufacturer's ecommerce website 121, using affiliate-specific data and this access may be tracked by the RNA 100, for example as described in or similar to that described in the various methods disclosed herein.

At 616, the referred consumer 135 may complete a target action on the manufacturer's website 121 and the may be tracked by RNA 100, for example as described in or similar to that described in the various methods disclosed herein.

At 618, the RNA 100 may act as a trusted third-party to broker compensation from the manufacturer merchant(s) 120 to the retail affiliate 111 and/or entity affiliate 112, for example as described in or similar to that described in the various methods disclosed herein.

In addition to commission-based compensation from the manufacturer merchant(s) 120, the RNA 100 may also provide compensation (e.g., on a flat fee per square foot basis) to the retail affiliate 111 simply for participating in the retail promotions management program.

At 620, the RNA 100 may gather data relevant to retail promotions management, such as revenue attributed to specific promotional material, traffic achieved for specific promotional offers and/or retail space configurations. Although described at 620, the RNA 100 may gather such data throughout method 600. The RNA 100 may use any suitable tracking software 410 (e.g., foot traffic tracking and analysis software) to gather such data. The RNA 100 may analyze the gathered data (e.g., using suitable analytics software 412, including suitable network analytics and optimization algorithms) to improve or optimize management of retail promotions. The RNA 100 may perform this analysis using the presently gathered data alone, or together with previously gathered or other historical data. For example, analysis may reveal that certain in-store displays give rise to more revenue per square footage, and the RNA 100 may thus determine that such in-store displays are preferred. The RNA 100 may also determine preferred retail store layout, configuration of in-store displays, preferred price points, retail shelf layout, or other aspects of retail promotions management.

At 622, RNA 100 may provide the results of its analysis to the manufacturer merchants 120 and/or retail affiliate 111. The RNA 100 may act as a trusted third-party, to ensure that any sensitive or confidential information is not inappropriately shared in the analysis results. The analysis provided may include, for example, the conversion rates from store visitor to online visitor to online purchase for different product displays, price points, and/or promotional offers, for example.

Information from such analysis may be useful to the manufacturer merchant 120 and/or retail affiliate 111 to help improve its promotional offers, displays, price points, store layout and other aspects of retail promotions management. Such information may also help a manufacturer merchant 120 to select an appropriate retail affiliate 111 for promoting product(s) and/or service(s). Similarly, such information may help a retail affiliate 111 to select which product(s) and/or service(s) to promote in its retail space.

The RNA 100 may store data gathered from such retail promotions management programs as historical analytics data 414. The RNA 100 may require the participating manufacturer merchants 120 and/or retail affiliates 111 to agree to terms of service that may allow for the harvesting and use of analytics data. The RNA 100 may license its analytics data 414 to third parties, for example, and/or may use gathered analytics data 414 for other aspects of retail management, for example as described below.

Through the RNA 100, a manufacturer merchant 120 wishing to promote product(s) and/or service(s) in a retail space may be able to bid on retail space (with compensation to retail affiliates 111 and/or RNA 100) based on, for example, the average number of store visitors, the average number of online visitors, and average amount of online sales for a given retail affiliate 111, for example. The retail affiliate 111 may be free to accept or deny such bids from a manufacturer merchant 120 and/or may adhere to default, recommended retail management practices provided by the RNA 100.

This bidding process may introduce retail affiliates 111 to new manufacturer merchant(s) 120 and vice versa. The RNA 100 may actively promote one or more retail affiliates 111 (e.g., providing information about retail locations, online publishers and/or related entity affiliates 112) as a marketing package to manufacturer merchants 120.

The RNA 100 may apply auction algorithms between manufacturer merchants 120 and retail affiliates 111 to help increase the revenue yield (which may include commissions resulting from entity affiliates 112 as well as resulting from direct manufacturer advertising revenue based on product and brand exposure per square footage of retail space). For example, to secure space in a specific retail location and time period, a manufacturer merchant 120 may include a sponsorship fee in its bid to offset any revenue performance risk of its product offering.

The RNA 100 may use the historical analytics data as a basis to bid for retail space to showroom products and/or services. For example, the RNA 100 may generate an offer to an existing retail affiliate 111 (or an offer to recruit a non-affiliate retailer into the retail network 300) by offering the historical analytics data as an incentive to accept the offer. The historical analytics data may also enable the RNA 100 to determine what the offer should be valued at.

### Example Method for Market Testing

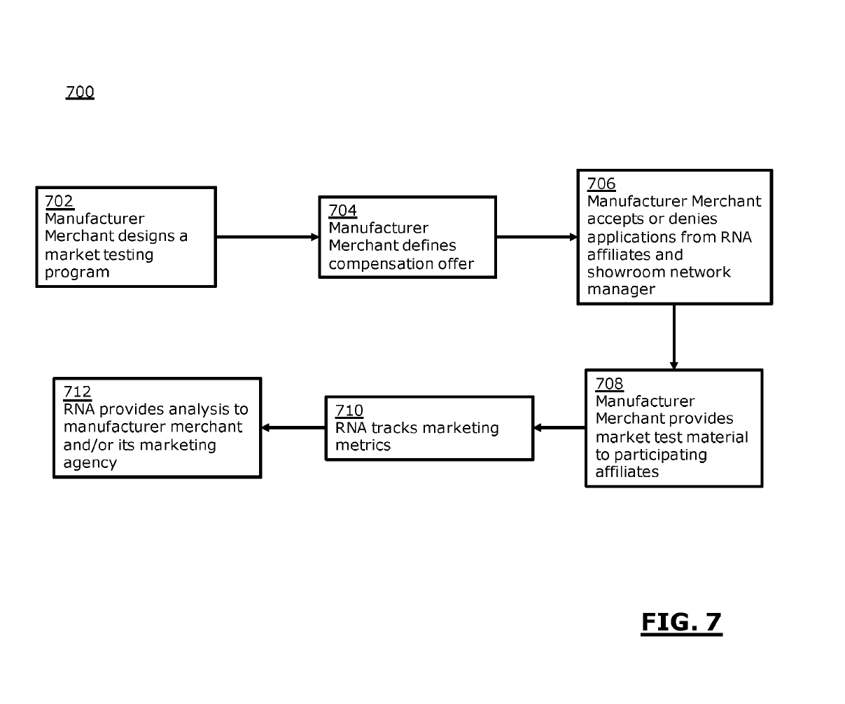

FIG. 7 is a flowchart illustrating an example method 700 for gathering retail information (also referred to as market testing), which method may be carried out by the example system of FIGS. 3 and 4.

The RNA 100 may provide its analytics software 412 and tracking software 410 as a service to manufacturer merchants 120. The network 300 of retail affiliates 111 managed by the RNA 100 may enable a manufacturer merchant 120 to carry out relatively fast and/or low-cost market testing of, for example, new products, new product packaging and/or promotional material (e.g., in-store displays). For example, a manufacturer merchant 120 may split test two or more different forms of product packaging in multiple retail locations, and determine the average product revenue per store visitor for each packaging format. The RNA 100 may monitor retail traffic and/or conversion rate of in-store visitors to online visits and/or actual purchases using suitable tracking software 410, for example, and provide such analytical information to the manufacturer merchant 120.

At 702, the manufacturer merchant 120 may design a market testing program. The program may be designed to test market receptiveness to, for example, an upcoming, new, or existing product, different product pricing, different product names, different packaging, different promotional displays, and may consider factors such as geographical region, time period, and/or retail traffic volume. In some examples, the RNA 100 may assist the manufacturer merchant 120 in designing such a market testing program, for example by providing historical or analytics data 414. The market testing program may be designed according to any suitable market testing techniques including, for example, a split test of versions A and B (e.g., to compare different products, packaging or pricing) or a simple baseline test (e.g., to test a single proposed version). The RNA 100 may have the option of approving or rejecting the market testing program, for example based on a set of criteria (e.g., minimum compensation, time scale and type of product tested).

At 704, the manufacturer merchant 120 may define the compensation offer (e.g., percentage of revenue, flat fee, or combination thereof) for retail affiliates 111 and/or entity affiliates 112 (an optionally for the RNA 100), which affiliates 111, 112 may browse, review, search and apply to participate in, for example as described in or similar to that described in the various methods disclosed herein.

At 706, the manufacturer merchant 120 may accept or deny applications from retail affiliates 111, for example based on certain criteria and goals, for example as described in or similar to that described in the various methods disclosed herein. A retail affiliate 111 applying to a market testing program may be required to agree to the use of certain standard analysis software 410 and/or tracking software 412 provided by the RNA 100.

At 708, the manufacturer merchant 120 may provide market test material (e.g., A and B versions of product displays, physical demo products, in-store displays, coupons, and other physical or electronic materials) to participating retail affiliates 111. Such materials may be provided directly from the manufacturer merchant 120 to the retail affiliates 111, or may be provided via the RNA 100, for example as described in or similar to that described in the various methods disclosed herein.

At 710, the RNA 100 may track certain metrics (e.g., revenue, referrals, and website visitors per average in-store visitor and web visitor) using suitable tracking software 412, for example as described in or similar to that described in the various methods disclosed herein. For example, in a split test program, metrics may be tracked and managed by the RNA 100 for version A and/or version B offers.

At 712, the RNA 100 may gather and analyze market data and may provide such results to the manufacturer merchant 120 and/or its marketing agency, for example as described in or similar to that described in the various methods disclosed herein. The RNA 100 may be compensated (e.g., on a flat fee basis, or through a royalty/annuity payment as a portion of the increased revenue achieved as a result of market testing) by the manufacturer merchant 120 for this service.

The RNA 100 may store data gathered from such market testing as historical analytics data 414. The RNA 100, in accepting a proposed market testing program from a manufacturer merchant 120, may require the manufacturer merchant 120 to agree to terms of service that may allow for the harvesting and use of analytics data from the market test program. The RNA 100 may license its analytics data 414 to third parties, for example, and/or may use gathered analytics data 414 for other aspects of retail management, for example as described in or similar to that described in the various methods disclosed herein. The RNA 100 may ensure that confidentiality and/or privacy of the manufacturer merchant 120 is maintained when sharing the gathered analytics data 414.

### Example Method of Remarketing

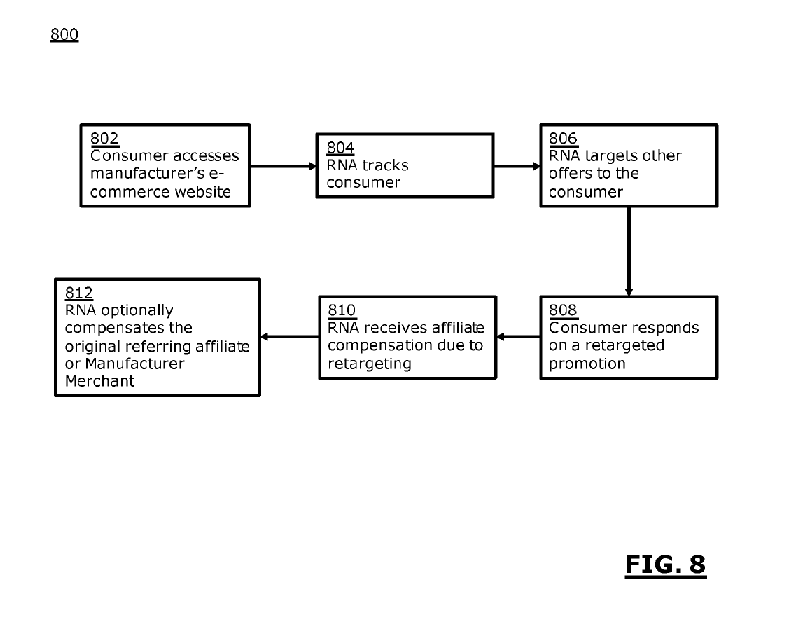

FIG. 8 is a flowchart illustrating an example method 800 for remarketing, which method may be carried out by the example system of FIGS. 3 and 4.

As described above, the RNA 100 may use tracking software 412 to track a referred consumer 135 or entity affiliate 112 who visits a manufacturer's website 121. A non-affiliate consumer 130 may be similar tracked, even where the consumer 130 was not referred to the website 121 by an affiliate 111, 112. Tracking software 412 may, for example, use cookie technology to associate a consumer 112, 130, 135 with a cookie on the consumer's 112, 130, 135 web browser, as a result of accessing a manufacturer's e-commerce website 121. Using that tracking information, the RNA 100 may promote other relevant products (e.g., from the same or different manufacturer merchant 120) to the consumer 112, 130, 135 while they are on other websites across the Internet.

At 802, the consumer 112, 130, 135 visits a manufacturer merchant's website 121 (e.g., belonging to manufacturer merchant A 120a). The visit may result from a referral (e.g., referred through an affiliate-specific link, using a coupon code or otherwise referred by an affiliate 111, 112) or not through a referral, for example as described as or similar to that described in the various methods disclosed herein.

At 804, the RNA 100 may track the consumer 112, 130, 135. For example, the RNA 100 may use tracking software 412 to implement a retargeting tracking mechanism (e.g., a special web browser cookie linked into a retargeting network) to track the consumer 112, 130, 135 visit to the website 121. The consumer 112, 130, 135 may be identified by the tracking software 412 as being interested in certain product(s) and/or service(s) presented on the website 121, or as being interested in the manufacturer merchant 120 generally, for example as described as or similar to that described in the various methods disclosed herein. This tracking may be carried out even if the consumer 112, 130, 135 does not make any purchase on the website 121.

At 806, the RNA 100 may targets other offers to the consumer 112, 130, 135. For example, using information gathered by the tracking software 412, the consumer 112, 130, 135 may be identified as having certain interests. Based on the identified interests, certain product(s) and/or service(s) provided by the same or different manufacturer merchant 120 may be promoted to the consumer 112, 130, 135 as the consumer 112, 130, 135 navigates to other websites. A manufacturer merchant 120 may have the option of opting in or opting out of retargeting promotions, and may negotiate compensation schemes based on any such retargeting. Such preferences may be defined in the affiliate program for the manufacturer merchant 120 and stored in the manufacturer database 406 of the RNA 100.

In some examples, the consumer 112, 130, 135 may be provided with an option (e.g., via a dialog box) to refuse to participate in such tracking and/or retargeting. If the consumer 112, 130, 135 refuses to allow tracking and/or retargeting, the RNA 100 may not store tracking information (e.g., a web browser cookie) associated with the consumer 112, 130, 135 and the method 800 may not be carried out for that consumer 112, 130, 135.

At 808, the consumer 112, 130, 135 may respond to a retargeted promotion (e.g., by clicking on a retargeted advertisement promoting a related product). The response may be any target action including, for example, a visit to a retargeted website 121 or a purchase of a retargeted product and/or service). The tracking software 412 may be used to track such response and attribute the response to the original website 121 (from 802) and/or to the retargeting by the RNA 100. The response may benefit a manufacturer merchant B 120b different from the manufacturer merchant A 120a (from 802).

At 810, the RNA 100 may receive compensation from the manufacturer merchant 120 that benefited from the action at 808. Such compensation may be negotiated between the manufacturer merchant 120 and the RNA 100 beforehand and may be stored in the affiliate program for the manufacturer merchant 120.

At 812, the RNA 100 may optionally compensate the original referring affiliate 111, 112 or the original manufacturer merchant 120 (from 802) for the action at 808. Such compensation may be negotiated beforehand and may be billed or deducted from the manufacturer merchant 120 benefiting from the action at 808. This may be as described as or similar to that described in the various methods disclosed herein.

### Example Method for Implementing Coupons

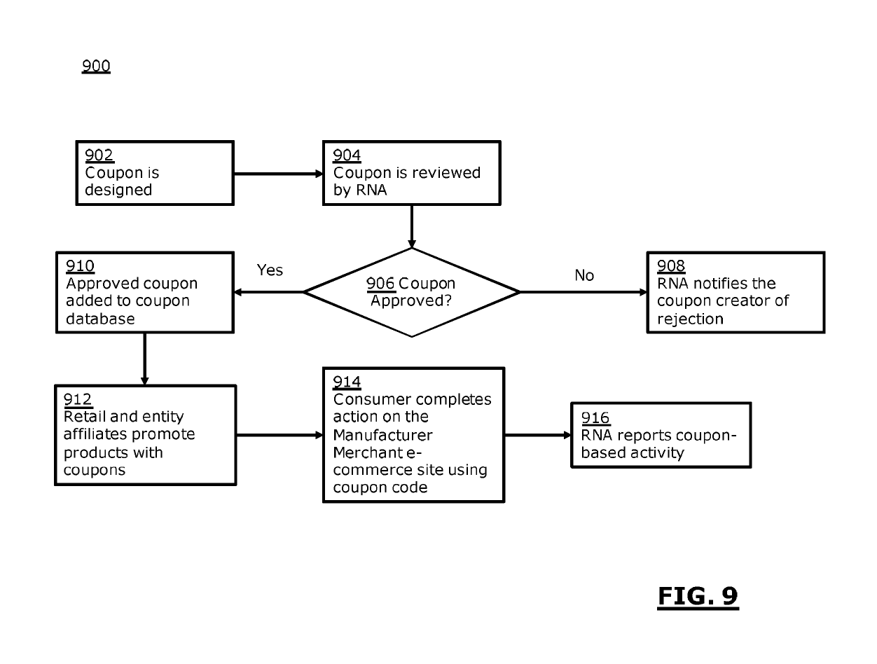

FIG. 9 is a flowchart illustrating an example method 900 for implementing coupons, which method may be carried out by the example system of FIGS. 3 and 4.

In some examples, the RNA 100 may enable manufacturer merchants 120, retail affiliates 111 and/or entity affiliates 112 to create and manage coupons for promotional purposes. The coupon may provide affiliate-specific data (e.g., a unique affiliate-specific URL and/or promo code) that may be used to attribute a referral. A coupon may be intended for any suitable promotional program (e.g., may be limited by quantity and/or date range, may provide pricing discounts, free shipping and/or bonus offers to be supplied by the manufacturer, retailer and/or affiliate, or any other suitable coupon promotions).

Creation of a coupon may include a definition of its distribution options (e.g., including online delivery, printed coupon cards, and/or coupon booklets). Bonus offers that may be offered by a coupon may include, for example, PR stunts (e.g., “I like this product so much I'll donate $10 to WWF for every friend who buys one” or “Celebrity X will do Y if we reach 1,000 sales today”) and third party products or offers.

Coupons may be stored in the coupon database 416 managed by the RNA 100. The RNA 100 may publish currently active or available coupons in a coupon directory that may be, for example, browsed and searched by manufacturer merchants 120 and affiliates 111, 112. The coupon directory may also be browsed and searched by referred consumers 135 as well as non-affiliate consumers 130. The RNA 100 may also actively communicate (e.g., via physical mailing or electronic communication) available coupons to entities wishing to receive such coupons. For example, an entity affiliate 112 may sign up to receive certain coupons based on geography and/or interest, and the RNA 100 may store such preferences in the corresponding affiliate program in the consumer database 404. In some examples, a manufacturer merchant 120 or a retail affiliate 111 may also pay the RNA 100 to issue coupons to consumers 112, 130, 135 (e.g., those local to the retail affiliate's retail store).

One or more coupons or a booklet of coupons may also be promoted by the RNA 100 via in-store promotional material (e.g., in-store displays) for a primary product (which may or may not be included in the coupon(s)). Coupon(s) thus promoted together with a primary product may promote product(s) and/or service(s) related to the primary product (e.g., having similar geographical locations and/or target market). Such co-promotions may be offered by the RNA 100 as advertising space to manufacturer merchants 120. A manufacturer merchant 120 may specify in its affiliate program whether or not such co-promotions are allowed for its product(s) and/or service(s).

At 902, a coupon is designed, for example by the manufacturer merchant 120 to promote one or more of its product(s) and/or service(s). A coupon may also be designed by an affiliate 111, 112 or by the RNA 100 for product(s) and/or service(s) of one or more manufacturer merchants 120. Where a coupon for product(s) and/or service(s) is designed by a party other than the manufacturer merchant 120 providing that product(s) and/or service(s), the coupon may require approval by the manufacturer merchant 120. For simplicity, method 900 will be described assuming that the coupon is designed by the manufacturer merchant 120, although other possibilities may be suitable.

As described above, the coupon may a physical or electronic coupon, and may provide affiliate-specific data (e.g., having a unique coupon code that identifies the affiliate 111, 112). The coupon may provide further information, such as promotion identifier and promotional material (e.g., images and logos). Promotions provided by the coupon may include, a bonus offer (e.g., a free gift, download, training experience or gift card) that may be provided when the coupon is redeemed. The coupon may have other attributes, such as limited with a maximum number of coupons (e.g., limited to first 100 customers) and/or to a specific time period, as described above. The coupon creator may also specify conditions and/or criteria for promoting the coupon. For example, the coupon creator may specify that the coupon may only be distributed by retail affiliates 111 fitting certain criteria (e.g., certain geographical locations or target market).

At 904, the proposed coupon may be submitted to the RNA 100 for review and approval or rejection by the RNA 100 (e.g., based on certain criteria, such as compensation levels, target market and aesthetics) prior to being added to the coupon database 416.

At 906, the coupon may be approved or not approved by the RNA 100.

At 908, if the RNA 100 rejects the proposed coupon, the RNA 100 may notify the coupon creator that the proposed coupon was rejected. The RNA 100 may provide additional information, such as shortcomings of the proposed coupon, to assist in improvement of the coupon.

At 910, if the RNA 100 approves the proposed coupon, the coupon may be added to the coupon database 416 managed by the RNA 100. The coupon may be published in a coupon directory and/or associated with the relevant manufacturer merchant(s) 120 in a manufacturer merchant directory managed by the RNA 100.

At 912, affiliates 111, 112 may browse and search for coupons in the coupon directory and/or merchant directory, for example as described in or similar to that described in the various methods disclosed herein. The affiliates 111, 112 may start promoting product(s) and/or service(s) with electronic coupons immediately and/or may sign up to receive physical or electronic coupons. In some examples, an affiliate 111, 112 may require approval from the manufacturer merchant 120 and/or the RNA 100, for example as described in or similar to that described in the various methods disclosed herein, before being able to receive selected coupons.

In some examples, the RNA 100 may automatically inform affiliates 111, 112 of new coupons available and/or may automatically provide new physical or electronic coupons to affiliates 111, 112. This may be based on preferences specified by an affiliate 111, 112, which preferences may be stored in the corresponding database 402, 404. For example, a retail affiliate 111 specializing in exercise equipment may set a preference to automatically receive electronic coupons for exercise-related products and services. When a new coupon for exercise-related products and services becomes available (e.g., is added to the coupon database 416), the RNA 100 may transmit the new coupon electronically to the retail affiliate 111, such that the retail affiliate 111 may use the new coupon for promotional purposes without having to search the coupon database 416 and download the new coupon manually.

At 914, a consumer 112, 130, 135 may complete a target action (e.g., a purchase) on the manufacturer merchant's e-commerce site 121 using affiliate-specific data provided on the coupon (e.g., promo codes or unique URL). Such activity may be identified and tracked by the RNA 100, for example as described in or similar to that described in the various methods disclosed herein.

At 916, the RNA 100 may gather data about coupon-based activity and may report such data to the manufacturer merchant 120 whose product(s) and/or service(s) is being promoted by the coupon and/or to the coupon creator. Any promotional activity promised by the coupon (e.g., bonus offers or PR stunts) may be carried out accordingly. Referrals and compensation may be tracked and resolved by the RNA 100, for example as described in or similar to that described in the various methods disclosed herein.

### Example Method of Co-Promoting Using Coupons

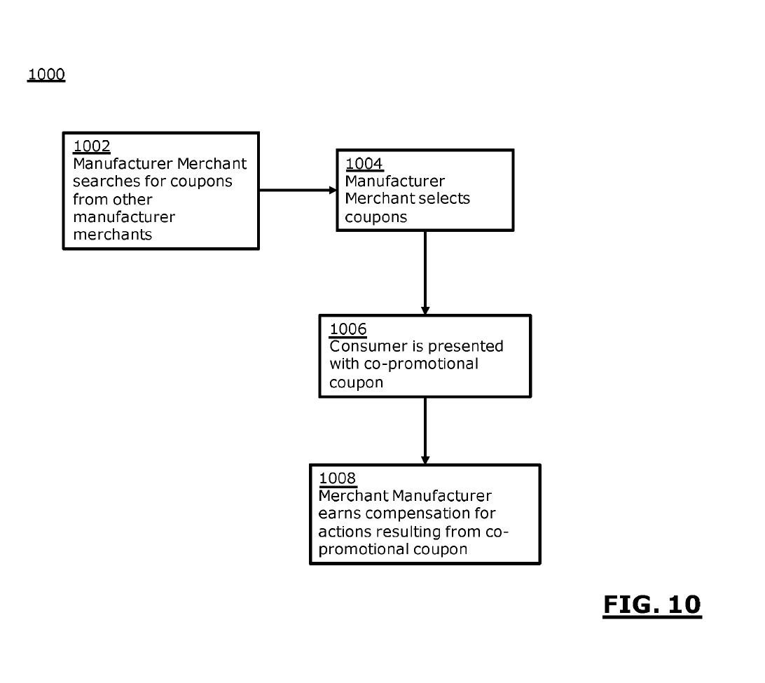

FIG. 10 is a flowchart illustrating an example method 1000 of co-promoting using coupons, which method may be carried out by the example system of FIGS. 3 and 4.

The RNA 100 may provide a manufacturer merchant 120 with the ability to customize a coupon booklet by selecting coupons from the coupon database 416, in order to co-promote (also referred to as cross-promote) product(s) and/or service(s) from other manufacturer merchants 120. A manufacturer merchant 120 may include the coupon booklet in product packaging, for example, in exchange for compensation (e.g., advertising revenue, percentage commission on any sales generated by coupon redemption and/or commission based on online traffic as a result of the coupon) from the co-promoted manufacturer merchant 120. Similarly, a retail affiliate 111 may be provided with the ability to customize a coupon booklet from the coupon database 416. For example, a retail affiliate 111 may customize a coupon booklet to be specific to the product(s) and/or service(s) offered in its retail stores.

At 1002, a manufacturer merchant 120a may search the coupon database 416 maintained by the RNA 100 for coupons from other manufacturer merchants 120b. For example, the manufacturer merchant 120a may wish to increase its revenue per product sold by including (e.g., with product packaging, checkout promotions and/or other online or offline promotions) co-promotions for product(s) and/or service(s) from other manufacturer merchants 120b. The manufacturer merchant 120a may also be able to invite other manufacturer merchants 120b to create coupon offers, or the manufacturer merchant 120a may itself create coupons for product(s) and/or service(s) from other manufacturer merchants 120b, for example as described in or similar to that described in the various methods disclosed herein.

At 1004, the manufacturer merchant 120a may select one or more coupons for co-promotion. The co-promotional coupons may include affiliate-specific data (e.g., promo code or affiliate-specific URL) identifying manufacturer merchant 120a as the co-promoter. The other manufacturer merchants 120b whose product(s) and/or service(s) may be co-promoted may be provided with an opportunity to accept or reject co-promotion by the manufacturer merchant 120a. For example, when the manufacturer merchant 120a selects coupons from the coupon database 416 to be used for co-promotion, the RNA 100 may inform the relevant other manufacturer merchants 120b and request the other manufacturer merchants 120b for approval. After such approval is obtained, the RNA 100 may provide the manufacturer merchant 120a with the co-promotional coupons (e.g., through physical delivery or electronic delivery of the coupons). In some examples, such approval by other manufacturer merchants 120b may not be necessary.

At 1006, a consumer 112, 130, 135 may be presented with the co-promotional coupon(s). For example, the coupon booklet may be provided to consumers 112, 130, 135 as a physical or electronic coupon booklet using various suitable channels (both within the affiliate network 300 and outside of the network 300), for example as described in or similar to that described in the various methods disclosed herein. For example, consumers 112, 130, 135 may be presented with one or more co-promotional coupons when consumers 112, 130, 135 access the manufacturer merchant's website 121a.

At 1008, the manufacturer merchant 120a may earn compensation from other manufacturer merchants 120b as a result of target actions (e.g., purchases) completed by consumers 112, 130, 135 using the co-promotional coupons. The RNA 100 may track referrals and actions stemming from the co-promotional coupons (e.g., based on the affiliate-specific data provided in the coupon) and may broker compensation accordingly, for example as described in or similar to that described in the various methods disclosed herein.

In the example method 1000, as well as in various other methods disclosed herein, the RNA 100 may act as a trusted third-party broker between different manufacturer merchants 120a, 120b.

### Example Method of Coupon Redemption by a Consumer

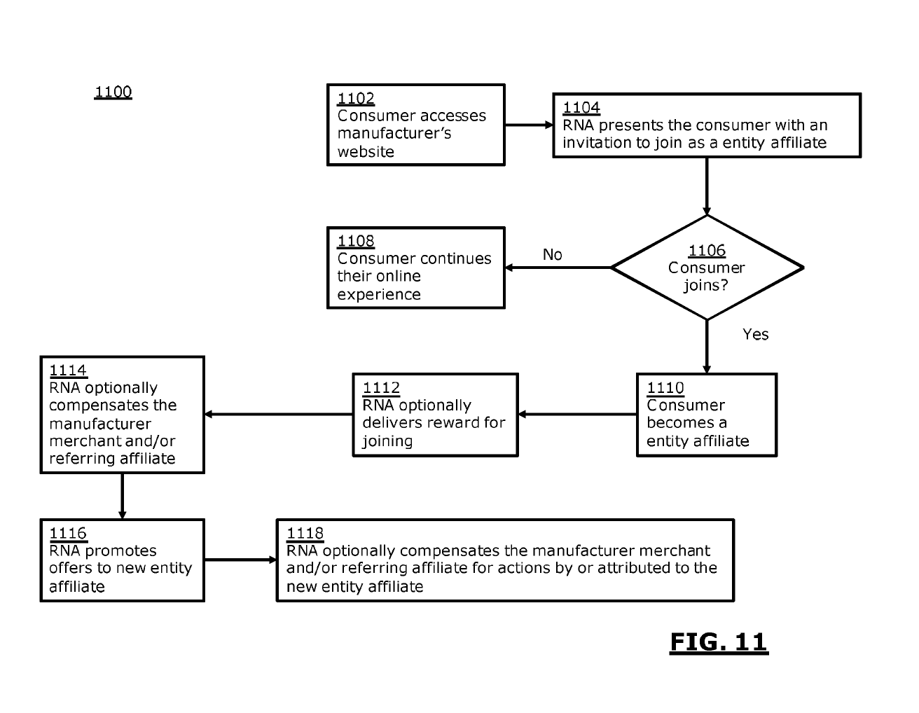

FIG. 11 is a flowchart illustrating an example method 1100 for recruiting a referred consumer 135 as a new entity affiliate 112, which method may be carried out by the example system of FIGS. 3 and 4.

The example coupon redemption method 1100 may result in a referred consumer 135 becoming a new entity affiliate 112. The new entity affiliate 112 may initially be provided with promotional material only from an initial referring retail affiliate 111 or manufacturer merchant 120. The RNA 100 may present the new entity affiliate 112 with opportunities to promote other product(s) and/or service(s) from the same or other manufacturer merchants 120. The original referring retail affiliate 111, entity affiliate 112 or manufacturer merchant 120 who originally referred the new entity affiliate 112 to join the retail & entity affiliate network 110 may receive compensation (e.g., based on promotions and/or sales attributed to the new entity affiliate 112).

At 1102, a consumer 130, 135 who is not yet an entity affiliate 112 may access a manufacturer merchant's website 121. The visit to the website 121 may be the result of a promotion from a retail affiliate 111 or an existing entity affiliate 112, for example. Any originating referral may be tracked by the RNA 100, for example as described above.

At 1104, before, during, or following the consumer's 130, 135 to the manufacturer merchant's website 121, the RNA 100 may present the consumer 130, 135 with an invitation to become an entity affiliate 112. In some examples, such an invitation may be displayed together with the website 121 while the consumer 130, 135 is viewing the website 121. In some examples, where the consumer 130, 135 provides contact information to the website 121 (e.g., the consumer 130, 135 provides an email address), the invitation may be communicated to the consumer 130, 135 using the contact information (e.g., in an email communication). This invitation may be presented to the consumer 130, 135 whether or not the consumer 130, 135 completes a purchase on the website 121. In some examples, the invitation may be presented to the consumer 130, 135 after completion of a purchase on the website 121, or during processing of a purchase on the website.

The invitation may include a promotion or incentive for joining (e.g., “tell your friends about this product and get free shipping”). In some examples, the manufacturer merchant 120 may specify whether or not such invitations are allowed to be displayed on its website 121, and such preference may be stored in the corresponding affiliate program in the manufacturer database 406.

At 1106, the consumer 130, 135 may have the option of joining or not joining as an entity affiliate 112. The consumer 130, 135 may be presented with terms and conditions for joining.

At 1108, if the consumer 130, 135 does not join as an entity affiliate 112, then the consumer 130, 135 may continue in their online experience as usual.

At 1110, if the consumer 130, 135 accepts the terms and conditions, the consumer 130, 135 may become a new entity affiliate 112. The new entity affiliate 112 may, at this time or at a later time, be provided with options for setting preferences (e.g., what promotions to be presented with) and/or a profile (e.g., age, geographical region and interests). Such information may be stored in the corresponding affiliate program in the consumer database 404 of the RNA 100.

At 1112, optionally, if the invitation to join included any promotions or incentives, such reward may be delivered by the RNA 100 to the new entity affiliate 112 at this time or at a later time.

At 1114, optionally, the RNA 100 may compensate the original manufacturer merchant 120 and/or referring affiliate 111, 112 (from 1102) according to a compensation agreement (e.g., as set forth in the corresponding affiliate program), which may be negotiated and defined as described above.

At 1116, the RNA 100 may promote offers to the new entity affiliate 112. The new entity affiliate may interact with the RNA 100 and other parties of the retail network 300, as described elsewhere in the present disclosure.

At 1118, optionally, the RNA 100 may compensate the original manufacturer merchant 120 and/or referring affiliate 111, 112 (from 1102) for further actions (e.g., purchases) performed by or attributed to the new entity affiliate 112. For example, if the new entity affiliate 112 makes a purchase or refers another consumer to make a purchase, the original manufacturer merchant 120 and/or referring affiliate 111, 112 (from 1102) may receive compensation for the purchase (e.g., according to a compensation agreement).

Any compensation earned by the new entity affiliate 112 may be managed and paid out by the manufacturer merchant 120, as described elsewhere in the present disclosure.

### Example Method for Managing a Product Review

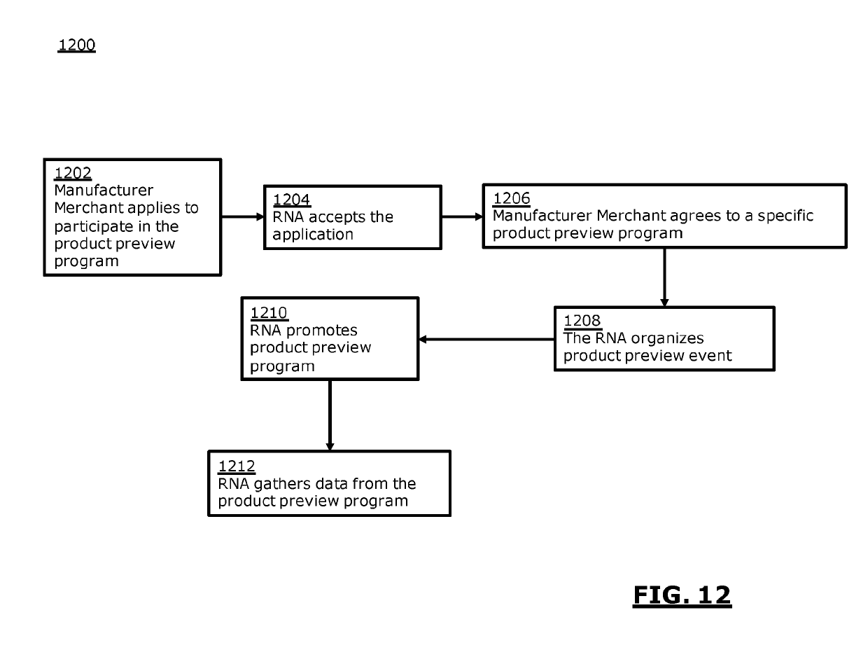

FIG. 12 is a flowchart illustrating an example method 1200 for managing a product preview, which method may be carried out by the example system of FIGS. 3 and 4.

The RNA 100 may offer manufacturer merchants 120 the ability to run a preview (e.g., a pre-launch auction) of new products that are not yet available on the mass market. For example, pre-launch products may be displayed in select retail affiliate 111 locations, with the option for consumers 112, 130, 135 to pay a pre-launch purchase price (which may be greater than or less than a post-launch price). A purchased product may be delivered to the consumer 112, 130, 135 after official launch of the product (e.g., 3-4 weeks following the preview promotion). The preview may be in the form of an auction (e.g., a live online or in-person auction) for the pre-launch product.

The product preview may be designed by the manufacturer merchant 120 and/or the RNA 100. For example, the product preview may be targeted towards a desired target market with certain promotions. The product preview may be time limited (e.g., a preview auction may be limited in time, such as a single day, a single time period within a day or repeated for a limited number of days) and/or limited by quantity (e.g., 100 to 500 units total or per auction day). By placing such restrictions on the product preview, consumer excitement and a sense of exclusivity and status may be created.

In some examples, the RNA 100 may run giveaways (e.g., as a form of sponsorship or advertising) for products on behalf of the manufacturer merchant 120 (e.g., “become an affiliate and get a chance to win X”). For example, if a non-affiliate consumer 130 signs up to become an entity affiliate 112, the new entity affiliate 112 may have the chance to win a prize (e.g., one prize may be awarded randomly to new affiliate 112 on a one-time or weekly basis). Such a giveaway promotion may be an incentive for non-affiliate consumers 130 to sign up as entity affiliates 112.

A product preview, such as a pre-launch auction, may be promoted by entity affiliates 112, such as celebrity affiliates, who may earn compensation for promoting the preview (compensation earned may be kept by the celebrity affiliate or donated to a participating charity, for example). A product preview may include multiple events, such as a live auction, a product launch event and/or a live online group auction (e.g., with dynamic bidding up to each participant's maximum bid, possibly integrated with an existing online auction platform). Retail affiliates 111 and entity affiliates 112 may refer referred consumers 135 to the product preview and may earn compensation for any sales resulting from the referral, for example. Information may be gathered about participants in the auction (e.g., non-affiliate consumers 130 and/or referred consumers 135, as well as existing entity affiliates 112) for further promotional efforts (e.g., for future coupon-based promotions, such as described above).

At 1202, a manufacturer merchant 120 may apply to participate in a product preview program managed by the RNA 100. The product preview program may be defined by the RNA 100, for example. In some examples, the manufacturer merchant 120 may have the ability to browse and search upcoming or proposed product preview programs using a directory listing provided by the RNA 100 and/or may have the ability to propose a product preview program, for example similar to that described above for coupon promotions. The product preview program may be designed to promote and/or sell products before they are officially launched and available for regular delivery. An example of a product preview program may include a pre-launch auction, as described above.

At 1204, the RNA 100 may accept the application. This acceptance may be based on certain criteria and may include negotiation of compensation terms, similar to that described in method 500. Agreed upon compensation may include compensation to the RNA 100 for facilitating the product preview program. Such terms may be specified in the affiliate program corresponding to the manufacturer merchant 120 and stored in the manufacturer database 406.

At 1206, the manufacturer merchant 120 may agree to the specifics of the product preview program. For example, a product preview program may include specific promotional material, such as a display of product information (e.g., digital, printed, or physical displays) and/or demonstration products. A product preview program may also specify the geographical location(s), retail affiliate(s) 111 and/or time period(s) for the preview.

In some examples, the product preview program may include the ability for consumers 112, 130, 135 to pre-order the product (e.g., through promotional affiliate-specific links or coupons) with a special promotional offer prior to the product becoming available, or take another action such as signing up for access to a pre-launch auction.

At 1208, the RNA 100 may organize one or more product preview events. Such events may include, for example, pre-launch auctions through which a limited number of products may be promoted and sold at pre-launch auction-based prices, special introductory prices and/or in connection with other offers. Pricing and/or promotions presented at such product preview events may be different from that of the product after official launch, which may be justified on the basis that there is a limited number of products to be released prior to the official product launch.

The RNA 100 may also organize giveaway incentives to encourage consumers 112, 130, 135 to purchase or sign up for the product and/or to join as an entity affiliate 112 (in the case of non-affiliate consumers 130 and referred consumers 135).

The RNA 100 may also arrange for a celebrity to promote and host the product preview event (e.g., as a host of a pre-launch auction). The RNA 100 may also partner with other promotional channels (e.g., TV shows or networks) to help increase the exposure of the product preview program.

Other such activities may be taken by the RNA 100 on behalf of the manufacturer merchant 120, as part of organizing one or more product preview events. In some examples, the extent of participation of the RNA 100 and/or compensation to the RNA 100 for such participation may be defined as part of the product preview program and may be agreed upon as part of 1206.

At 1210, the RNA 100 may promote the product preview program to its affiliates 111, 112 (e.g., through various physical and electronic communications, such as described elsewhere in this disclosure).

At 1212, the RNA 100 may gather data from the product preview program. For example, the RNA 100 may use tracking software 410 to track and gather relevant metrics, for example as described above, which data may be stored as historical analytics data 414. The data may be analyzed (e.g., using analysis software 412) and the results may be provided to the manufacturer merchant 120 (e.g., in exchange for compensation agreed to beforehand).

In some examples, the method 1200 may be combined with one or more of the methods disclosed herein. For example, market testing of alternate offers (e.g., as described in method 700) may be carried out in combination with the product preview.

### Example Method for Promoting a New Product

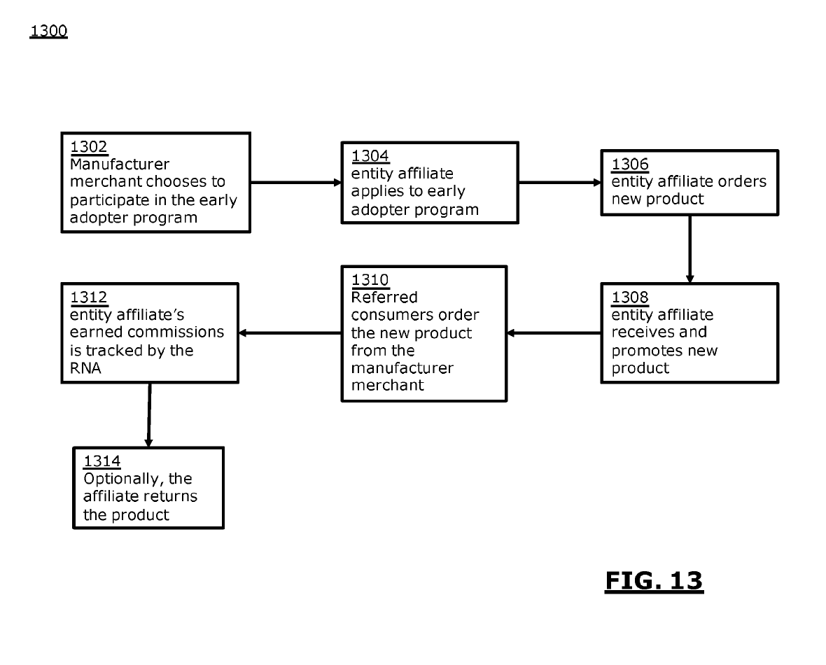

FIG. 13 is a flowchart illustrating an example method 1300 for promoting a new product, which method may be carried out by the example system of FIGS. 3 and 4.

In some examples, the RNA 100 may enable promotion of a new product, for example through an early adopter program for entity affiliates 112 who are interested in trying new products. Such early adopter entity affiliates 112 may be approved and/or invited to participate in promotion of a new product on the basis of their contacts (e.g., the extent of their social media presence). An early adopter entity affiliate 112, may purchase a new product with deferred payment terms, which may be offset by commissions arising from the promotion of the new product by the entity affiliate 112.

At 1302, a manufacturer merchant 120 may choose to participate in a new product promotion program, also referred to as an early adopter program. The new product promotion program may be defined by the RNA 100, for example. Similar to method 1200, the manufacturer merchant 120 may browse and search for a new product promotion program using a directory provided by the RNA 100 and/or may be able to propose its own new product promotion program, for example.

At 1304, an entity affiliate 112 may apply to participate in a new product promotion program for a new product and/or service from the manufacturer merchant 120. The entity affiliate 112 may browse and search for new product promotion programs in a manner similar to that described above for other promotional programs. The application by the entity affiliate 112 may be accepted or rejected, for example as described above for other promotional programs.

At 1306, after the entity affiliate 112 joins the new product promotion program, the entity affiliate 112 may order the new product and/or service (e.g., over the manufacturer's website 121). When the entity affiliate 112 orders the new product and/or service, the entity affiliate 112 may provide a unique code indicating that the entity affiliate 112 is a participant in the new product promotion program, in order to, for example, receive special discounts and/or bonuses. The entity affiliate 112 may purchase the new product and/or service, possibly with deferred payment over a specific period such as 30, 60, 90, 180, or 365 days, for example.

At 1308, the entity affiliate 112 may receive the new product and/or service and may begin to promote the new product and/or service. The entity affiliate 112 may be provided with affiliate-specific data (e.g., affiliate-specific link, coupon and/or promo code) in order to promote the new product and/or service online and/or offline to contacts, for example as described in or similar to that described in the various methods disclosed herein.

At 1310, referred consumers 135 may order the new product and/or service from the manufacturer merchant 120 (e.g., via the manufacturer's e-commerce website 121). The referred consumers 135 may make such orders using the affiliate-specific data promoted by the entity affiliate 112 in 1308.

At 1312, the RNA 100 may track (e.g., using tracking software 410) activity (e.g., purchases by referred consumers 135) attributed to the entity affiliate 112 and any compensation earned by the entity affiliate 112, for example as described in or similar to that described in the various methods disclosed herein.

In some examples, such as where the entity affiliate 112 has not paid the full price for the new product and/or service at 1306, any compensation earned by the entity affiliate may be held by the RNA 100 until the earned compensation makes up for the price that the entity affiliate 112 would have normally paid to buy the new product and/or service. In some examples, there may be a defined time period within which the entity affiliate 112 may earn compensation towards paying off the new product and/or service. If after expiring of this time period the entity affiliate 112 has not earned sufficient compensation to cover the price of the new product and/or service, the RNA 100 may bill the entity affiliate 112 for the outstanding amount.

In some examples, there may be no withholding of earned compensation from the entity affiliate 112. This may be the case where, for example, the amount of promotion gained by having the entity affiliate 112 as an early adopter is considered to be worth providing the new product and/or service to the entity affiliate 112 at a reduced price or for free.

At 1314, optionally, if applicable based on the manufacturer merchant's 120 product return program, the entity affiliate 112 may choose to return the product, in which case any earned compensation may be paid out to the entity affiliate via the RNA 100, for example as described in or similar to that described in the various methods disclosed herein.

In the method 1300, where the entity affiliate 112 is provided with the new product and/or service for free or at a reduced price, the difference with the regular price of the product and/or service may be absorbed by the manufacturer merchant 120 and/or the RNA 100. This difference may be paid back by the entity affiliate 112, for example by withholding earned compensation, as at 1312. In some examples, the entity affiliate 112 may not need to pay back the price difference.

### Example Method for Managing Virtual Retail

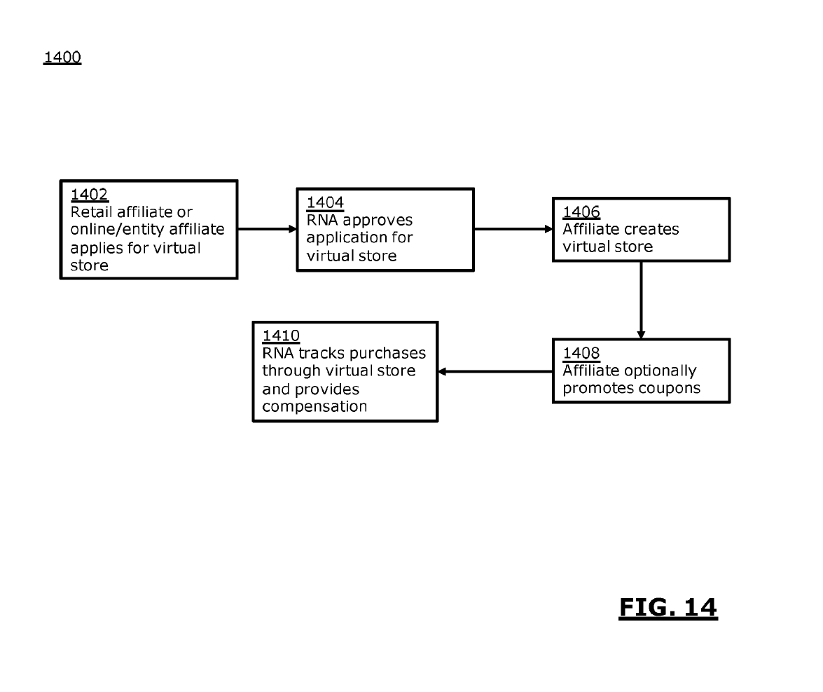

FIG. 14 is a flowchart illustrating an example method 1400 for managing virtual retail, which method may be carried out by the example system of FIGS. 3 and 4.

At 1402, an affiliate 111, 112 may apply to the RNA 100 to create a virtual (e.g., online) store of one or more products and/or services provided by one or more manufacturer merchants 120. The RNA 100 may provide the affiliate 111, 112 with the ability to browse and search for products and/or services to include in the virtual store, for example as described in or similar to that described in the various methods disclosed herein.

The application to create a virtual store may include, for example, a proposed list of product(s) and/or service(s) to sell through the virtual store, a proposed appearance of the virtual store and/or proposed target market for the virtual store. The virtual store may sell product(s) and/or service(s) from more than one manufacturer merchant 120. Alternatively, the affiliate 111, 112 may not be required to define the virtual store until creation of the store at 1406 below.

At 1404, the RNA 100 may approve the application for the virtual store, for example as described in or similar to that described in the various methods disclosed herein.

At 1406, the affiliate 111, 112 may create the virtual store (e.g., as proposed in the application at 1402). The virtual store may be a standalone web experience (e.g., with a unique affiliate-specific electronic address and/or domain name), part of a social network site (e.g., a Facebook-based store) and/or in the form of a mobile application, for example. In some examples, the virtual store may have multiple forms, for selling product(s) and/or service(s) across multiple platforms.

At 1408, the affiliate 111, 112 may optionally promote coupons (for example as described in or similar to that described in the various methods disclosed herein). Such coupons may be published within the virtual store and/or used as promotion tools to attract visitors to the virtual store.

The RNA 100 may assist the affiliate 111, 112 with various promotional tools (e.g., email marketing, giveaway contests, a blog as part of the store, or social media tools) to promote the virtual store.

At 1410, the RNA 100 may track purchases completed through the virtual store and may provide the affiliate 111, 112 with corresponding compensation, for example as described in or similar to that described in the various methods disclosed herein.

The virtual store may also enable remarketing (for example as described in or similar to that described in the various methods disclosed herein) to visitors to the virtual store, which may result in additional compensation for the affiliate 111, 112.

As described elsewhere in the present disclosure, compensation earned by the affiliate 111, 112 through its virtual store may be paid directly to the affiliate 111, 112, retained by the manufacturer merchant(s) 120 or paid to a charity. The virtual store may also be used to present incentives to buy through the affiliate network 300 (e.g., “Buy through this link and we'll donate $X for each purchase, or you will receive a bonus gift of Y.”), for example as described elsewhere in the present disclosure.

In some examples, the virtual store (or parts of the virtual store) may for fundraising purposes. For example, the affiliate 111, 112 may be a fundraising organization (e.g., schools, charities, and other fundraising organizations) and/or may be part of a fundraising effort. Promotional material may be tailored to fundraising efforts (e.g., including videos, blogging, and social features to create awareness and encourage visitors to purchase a product, spread the word, or donate). The RNA 100 may pay any compensation earned to the affiliate 111, 112 or directly to the fundraising effort (e.g., directly to the charity). The RNA 100 may also provide special administrative support services to the affiliate 111, 112, such as tax receipts and charity/gift/donation handling.

### Example Method for Promoting a Product Via a Catalogue

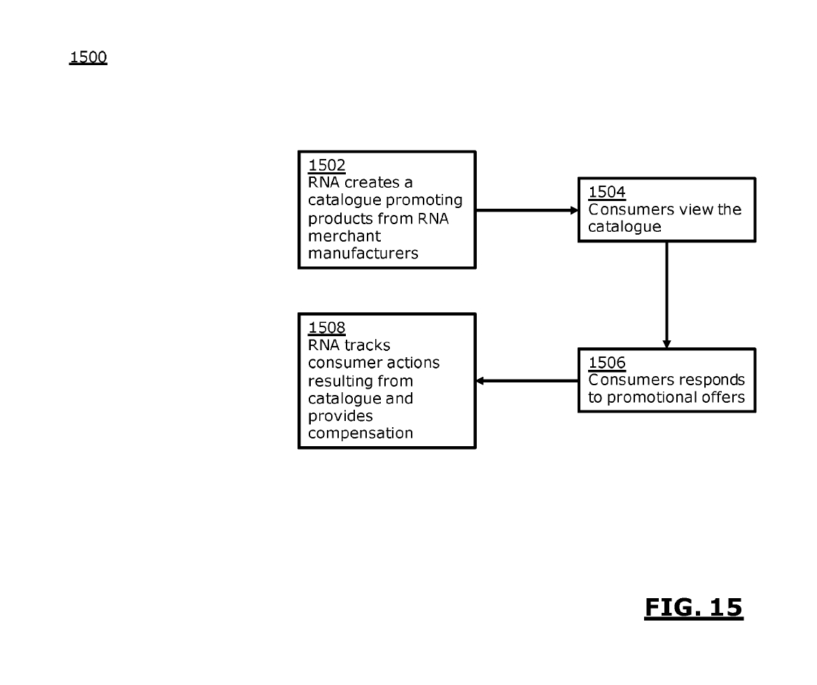

FIG. 15 is a flowchart illustrating an example method 1600 for promoting a product via a catalogue, which method may be carried out by the example system of FIGS. 3 and 4.

At 1502, the RNA 100 may create a catalogue to promote product(s) and/or service(s) from one or more manufacturer merchants 120. It should be understood that instead of a catalogue, other physical promotional material, such as a magazine or a magazine insert may be created. The term “catalogue” may be used to generally refer to such material, for simplicity. The catalogue may be created to target a certain target market.

The catalogue may be created on behalf of a retail affiliate 111 (e.g., upon request by the retail affiliate 111). The retail affiliate 111 may co-brand and/or co-publish the catalogue with its own brand and content, for example. In some examples, the RNA 100 may provide content for the catalogue (e.g., by drawing upon resources provided by its other affiliates 111, 112, possibly in exchange for compensation).

The catalogue may be used to promote product(s) and/or service(s) with affiliate-specific data, such as coupon codes, affiliate-specific links, and/or QR codes, similar to the promotional methods described above.

At 1504, consumers 112, 130, 135 may view the catalogue, in physical form or electronic form.

At 1506, a consumer 112, 130, 135 may respond to promotional offers using the affiliate-specific data, for example as described in or similar to that described in the various methods disclosed herein. For example, a consumer 112, 130, 135 may visit a manufacturer's website 121 using an affiliate-specific code provided in the catalogue and make a purchase.

At 1508, the RNA 100 may track the response to the catalogue (e.g., using tracking software 410) and may compensate the retail affiliate 111 accordingly, for example as described in or similar to that described in the various methods disclosed herein.

### Example Method for Promoting a Product in a Non-Retail Environment

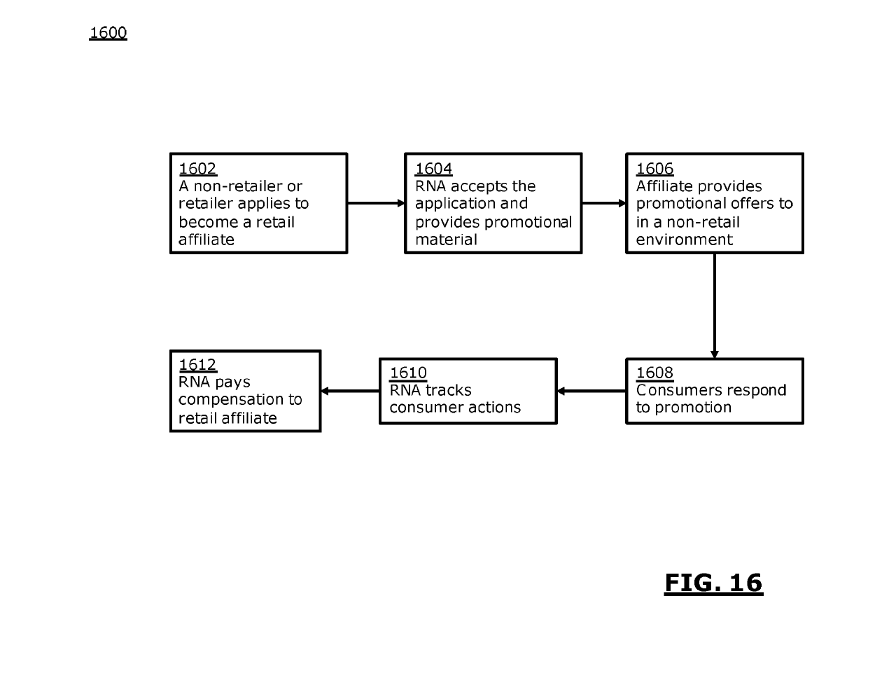

FIG. 16 is a flowchart illustrating an example method 1600 for promoting a product in a non-retail environment, which method may be carried out by the example system of FIGS. 3 and 4.

A non-retail environment may be an environment, such as a waiting room, which does not specialize in retail but where consumers 112, 130, 135 may be exposed to promotions for products and/or services. Examples may include auto care locations, medical offices, malls, and taxis (e.g., on the back of a headrest), among others. A non-retail environment may be managed by a retailer (e.g., at an auto service station within or adjacent to a retail store) or a non-retailer.

The promotional material may be, for example, a poster-sized or tablet-sized electronic display (e.g., with touch screen technology) or non-electronic display. In the case of an electronic display, consumers 112, 130, 135 may be able to select categories (e.g., beauty and wellness, health (such as workout equipment or back therapy services), clothing, sporting goods (such as for fishing or golf), or home appliances, among others) and/or specific product(s) or service(s) of interest from manufacturer merchants 120. In some examples, such as where electronic promotional material may be delivered by the RNA 100 through a communication network, the promotional material may be adjusted (e.g., dynamically or in real-time) based on consumer engagement (e.g., based on which promotions give rise to the most interactive behaviour) and/or sales, for example.

At 1602, a retailer or service provider (e.g., a dental office, health/wellness provider, travel service, taxi, auto care service, or restaurant, among others) that has a non-retail environment (e.g., a waiting area for consumers 112, 130, 135) may apply to become a retail affiliate 111. In some examples, the retailer or service provider may already be a retail affiliate 111 and 1602 may be omitted. A retail affiliate 111 thus need not be a retailer in the conventional sense.

At 1604, the RNA 100 may accept the application and may provide the new retail affiliate 111 with promotional material, for example as described in or similar to that described in the various methods disclosed herein. The RNA 100 may, for example, assist the retail affiliate 111 in selecting one or more promotional programs (e.g., through a merchant directory) and/or promotional tools (e.g., in-store displays, catalogue or coupons, among others). The promotional material provided to the retail affiliate 111 may include affiliate-specific data (e.g., unique promo codes) that may be used by the RNA 100 to track and attribute referrals from the retail affiliate 111.

At 1606, the retail affiliate 111 may present the promotional material to consumers 112, 130, 135 in the non-retail environment (e.g., while they are waiting for other services), for example as described in or similar to that described in the various methods disclosed herein.

At 1608, consumers 112, 130, 135 may respond to the promotions, for example as described in or similar to that described in the various methods disclosed herein.

At 1610, the RNA 100 may track consumer actions resulting from the promotions presented in the non-retail environment, for example as described in or similar to that described in the various methods disclosed herein.

At 1612, the RNA 100 may pay earned compensation to the retail affiliate, for example as described in or similar to that described in the various methods disclosed herein.

### Example Method for Promoting a Product in a Retail Environment

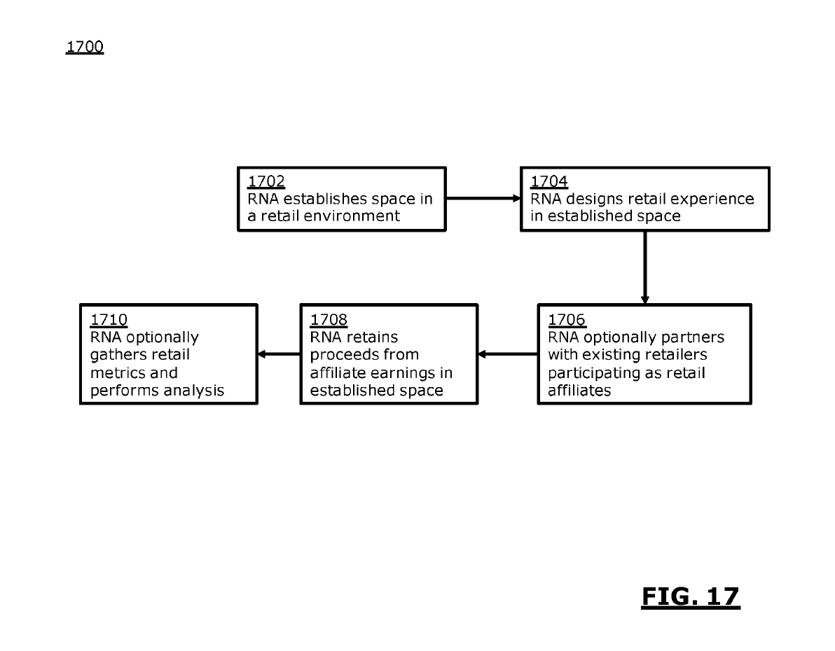

FIG. 17 is a flowchart illustrating an example method 1700 for promoting a product in a retail environment, which method may be carried out by the example system of FIGS. 3 and 4.

The method 1700 may be carried out in order to promote product(s) and/or service(s) within a retail environment (e.g., a retail store), for example in a retail kiosk, standalone retail store, or as a “store within a store” of an existing retailer.

At 1702, the RNA 100 may establish a space (e.g., a kiosk, retail store, or store-within-store) within a retail environment. The RNA 100 may rent a specific square footage within a retail environment, which may or may not be managed by a retail affiliate 111.

At 1704, the RNA 100 may design the retail experience in the established space. This may be based on retail space and promotions management (e.g., showroom optimization), for example as described in or similar to that described in the methods disclosed herein. The RNA 100 may implement technology (e.g., including use of tracking software 410) for tracking the volume of in-store visitors, for example.

At 1706, the RNA 100 may optionally partner with one or more existing retailers (which may or may not be a retail affiliate 111) to manage the established space. For example, the RNA 100 may directly employ staff (e.g., to manage product displays and respond to customer questions), may provide self-serve store experiences, and/or may employ resources (e.g., staff) of partner retailers.

At 1708, the RNA 100 may retain any proceeds from earnings by affiliates 111, 112 resulting from sales and other completed target actions by consumers 112, 130, 135 visiting the established space in the retail environment.

At 1710, the RNA 100 may optionally gather analytics data throughout the duration of the retail experience in the established space. The RNA 100 may analyze the gathered data (e.g., using analysis software 412) and/or may use retail space management (e.g., showroom optimization algorithms) to help improve ongoing revenue and earnings per square footage of retail space, for example as described in or similar to that described in the methods disclosed herein.

### Example Method for Promoting a Product in a Consumer Environment

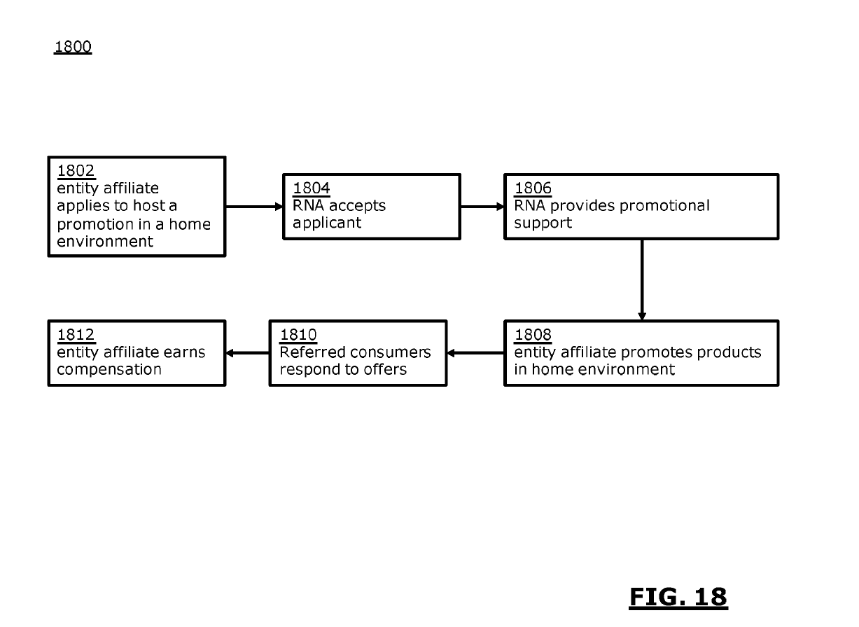

FIG. 18 is a flowchart illustrating an example method 1800 for promoting a product in a consumer environment, which method may be carried out by the example system of FIGS. 3 and 4.

At 1802, an entity affiliate 112 may apply to the RNA 100 to host a promotion in a consumer environment, such as the home of the entity affiliate 112 or other third-party environment (e.g., in a school or a banquet hall). In some examples, this may be carried out as part of a fundraising effort. Such a promotion may be referred to as a “home party”. The application may specify the product(s) and/or service(s) (which may be from one or more manufacturer merchants 120) the entity affiliate 112 wishes to promote and/or the promotional support (e.g., demo products) the entity affiliate 112 is seeking from the RNA 100, for example, among other factors.

At 1804, the RNA 100 may accept the applicant, for example after review of the application and ensuring that the application meets one or more criteria (for example as described in or similar to that described in the methods disclosed herein).

At 1806, the RNA 100 may provide the entity affiliate 112 with any requested promotional support (e.g., demo products, catering, and/or assistance in organizing, promoting, and hosting the promotion, among other support).

At 1808, the entity affiliate 112 may promote the product(s) and/or service(s) (e.g., to friends and other contacts of the entity affiliate 112) in the consumer environment. Promotional material, which may be provided by the RNA 100 at 1806, may allow the entity affiliate 112 to promote the product(s) and/or service(s) using coupons, catalogues and/or virtual stores, for example as described in or similar to that described in the methods disclosed herein.

At 1810, attendees at the promotion may become referred consumers 135 when they respond to one or more promoted offers. The referred consumers 135 may use affiliate-specific data (e.g., an affiliate-specific link or promo code) to carry out target actions (e.g., visiting manufacturer's website 121 and/or making a purchase). Such referrals may be tracked by the RNA 100 and attributed to the entity affiliate, for example as described in or similar to that described in the methods disclosed herein.

At 1812, the RNA 100 may determine the compensation earned by the entity affiliate 112 and may compensate the entity affiliate 112 (or a selected fundraising entity) accordingly, for example as described in or similar to that described in the methods disclosed herein.

After the promotion is finished (e.g., after the end of the “home party” or after the end of a predefined promotion period), the entity affiliate 112 may return remaining promotional material (e.g., a demo product) to the RNA 100. The entity affiliate 112 may transfer promotional material that is not affiliate-specific (e.g., a demo product or product display) to another entity affiliate 112. Such a transfer may be organized and approved by the RNA 100, for example when the RNA 100 has approved another entity affiliate 112 to host a promotion for the same product(s) and/or service(s) in a consumer environment. In some examples, where the entity affiliate 112 is provided with a demo product, the entity affiliate 112, after completion of the promotion, may be provided with the option to purchase the demo product. The entity affiliate 112 may be provided with the option to make such a purchase via the new product promotion program, for example as described in or similar to that described in the methods disclosed herein.

### Example Method for Managing Use of a Gift Card

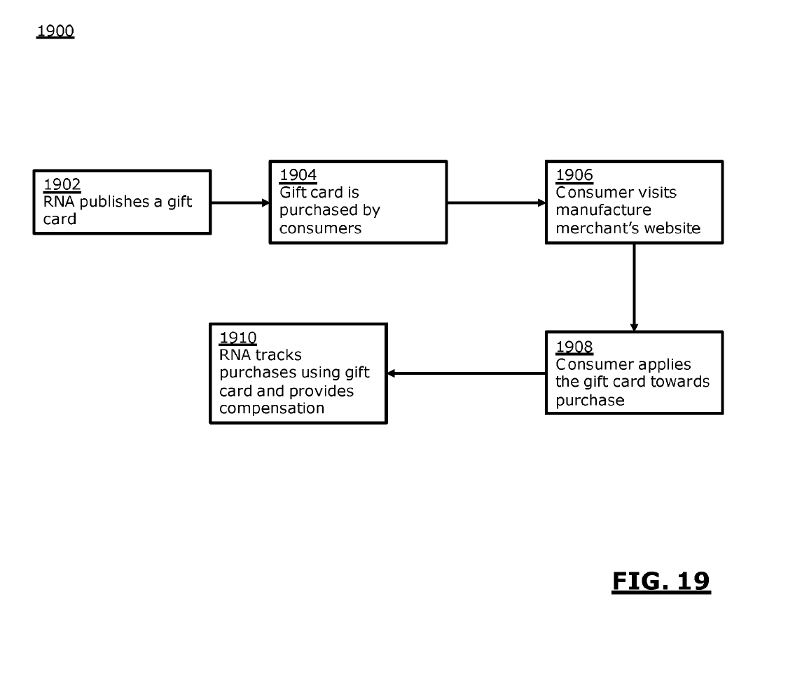

FIG. 19 is a flowchart illustrating an example method 1900 for managing use of a gift card, which method may be carried out by the example system of FIGS. 3 and 4.

At 1902, the RNA 100 may create and publish a gift card that may be applied to product(s) and/or service(s) sold by one or more manufacturer merchants 120. In some examples, a gift card may be proposed by a manufacturer merchant 120 and/or an affiliate 111, 112 and may be created and published only after review and approval by the RNA 100 (e.g., according to certain criteria), for example as described in or similar to that described in the methods disclosed herein.

A gift card may include data for the purpose of attributing referrals for purchases made using the gift card. For example the gift card may include an affiliate-specific link that is unique to the manufacturer merchant 120 and/or affiliate 111, 112 that proposed the gift card. The gift card may also provide information directing a consumer 112, 130, 135 to a virtual store, which may be operated by the RNA 100 itself or by an affiliate 111, 112, which may be operated for example as described in or similar to that described in the methods disclosed herein.

At 1904, a gift card may be purchased by a consumer 112, 130, 135. Such a purchase may be made in a retail location of a retail affiliate 111 stores, online, or from other retail locations. For example, the consumer 112, 130, 135 may be provided with the ability to browse and search for gift cards in an online gift card directory managed by the RNA 100, for example as described in or similar to that described in the methods disclosed herein.

At 1906, the consumer 112, 130, 135 may visit the manufacturer's website 121 or the virtual store (e.g., where the gift card include information directing the consumer 112, 130, 135 to the virtual store).

At 1908, the consumer 112, 130, 135 may apply the gift card towards a purchase at the manufacturer's website 121 or the virtual store. The consumer 112, 130, 135 may be prompted to provide unique data (e.g., an affiliate-specific code) provided on the gift card, which may be used to track referrals, in order to use the gift card.

At 1912, the RNA 100 may track actions (e.g., purchases) made via the gift card and may provide compensation to affiliates 111, 112 accordingly, for example as described in or similar to that described in the methods disclosed herein.

### Example Method for Attributing Referrals Based on Location

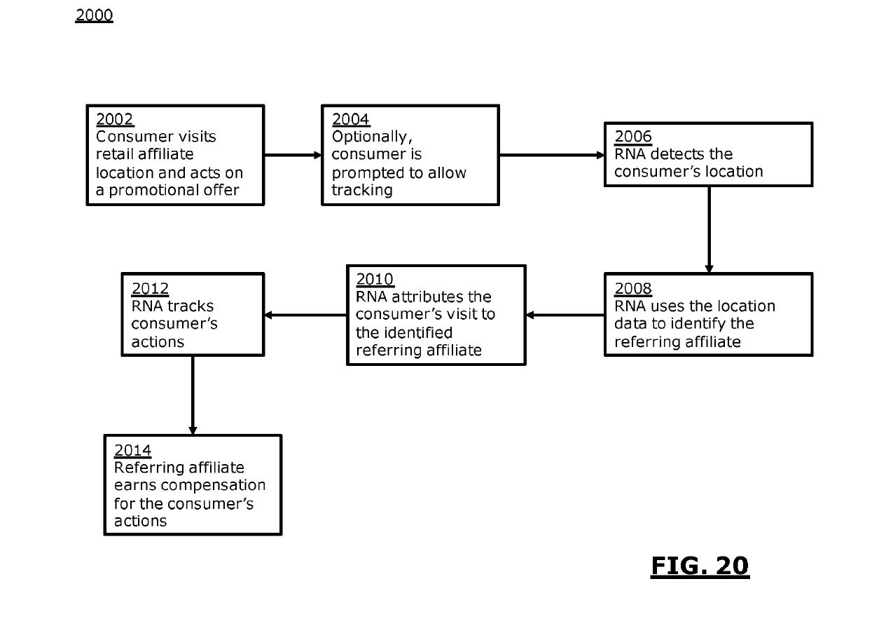

FIG. 20 is a flowchart illustrating an example method 2000 for attributing referrals based on location, which method may be carried out by the example system of FIGS. 3 and 4.

As described elsewhere in the disclosure, referrals may be tracked through the use of affiliate-specific data (e.g., an affiliate-specific link or code) that is used to carry out a target action (e.g., a purchase). In some examples, referrals may be tracked and properly attributed even without use of such affiliate-specific data.

In some examples, the RNA 100 may track actions performed by referred consumers 135 based on the physical location of the referred consumer 135. The location of the referred consumer 135 may be identified using suitable location technology, for example based on the WiFi network, IP address, GPS, smartphone functionality, or other suitable location technology (such as those that might be provided in mobile communication devices). Using the determined location of the referred consumer 135, the RNA 100 may be able to determine (e.g., by calculating which retail affiliate 111 is closest to the location of the referred consumer 135) the identity of the referring retail affiliate 111, and may compensate the identified referring retail affiliate 111 accordingly.

At 2002, the referred consumer 135 may visit a retail location of a retail affiliate 111 and may act on a promotional offer displayed in the retail location (e.g., by visiting a manufacturer's website 121, or activating a QR code or UPC code using a software application) using a mobile communication device (e.g., mobile phone, smartphone, personal digital assistant or tablet device)

At 2004, optionally, when the referred consumer 135 accesses a promotional offer the referred consumer 135 may be prompted (e.g., via a dialog box displayed on the mobile device) to allow the website 121 or application to determine the current location of the referred consumer 135 (e.g., “This website/app would like to your know your location: Allow or Decline”).

At 2006, the location of the referred consumer 135 may be determined by the RNA 100 (e.g., using suitable tracking software 410). This determination may be based on one or more factors including IP address, WiFi network, GPS, smartphone functionality or mobile wireless protocols, for example.

At 2008, the RNA 100 may use the location data to identify the retail affiliate 111 which is most likely to be the referring affiliate. For example, the physical retail locations of all retail affiliates 111 may be stored in the retailer database 402, and the RNA 100 may compare the location data of the referred consumer 135 to the retail locations stored in the retailer database 402. The retail affiliate 111 having a retail location closest to the location of the referred consumer 135 may be determined to be the referring affiliate.

At 2010 the RNA 100 may attribute the referred consumer's 135 visit to the identified referring retail affiliate 111.

At 2012, the RNA 100 may track any actions (e.g., purchases) made by the referred consumer 135 on the manufacturer merchant's website 121 or application, for example as described in or similar to that described in the methods disclosed herein.

At 2014, the referring retail affiliate 111 may earn compensation for the referred consumer's 135 actions, for example as described in or similar to that described in the methods disclosed herein.

Example Method for Managing Compensation from Multi-Step Referrals

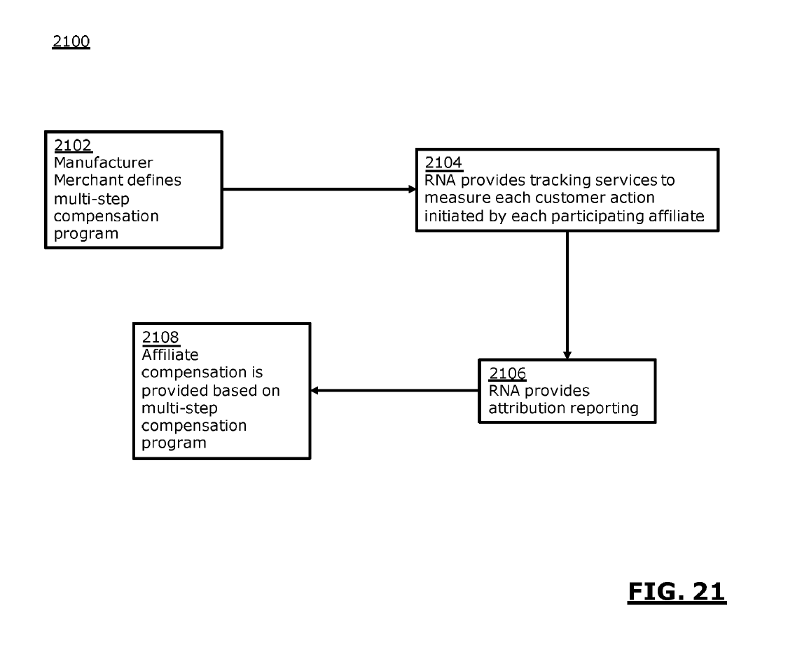

FIG. 21 is a flowchart illustrating an example method 2100 for managing compensation resulting from multi-step referrals, which method may be carried out by the example system of FIGS. 3 and 4.

In this example method, the RNA 100 may track more than one referral from one or more affiliates 111, 112 resulting in a single target action; and may provide compensation accordingly.

At 2102, the manufacturer merchant 120 may define a compensation program in which affiliates 111, 112 may be compensated for multiple referral steps (possibly over multiple contact channels) resulting in completion of a single target action (e.g., a single purchase) of a consumer 112, 130, 135. This may be defined, for example, in the manufacturer merchant's 120 affiliate program stored in the manufacturer database 406, for example as described in or similar to that described in the methods disclosed herein.

For example, the manufacturer merchant 120 may define one or more specific target actions (e.g., website visit, social referral, lead capture, first-time purchase, or repeat purchase) that may be attributable to an affiliate 111, 112, as well as the amount and/or type of compensation for each target action.

The manufacturer merchant 120 may define multiple referral steps for each target action for which compensation may be earned by an affiliate 111, 112. For example, the manufacturer merchant 120 may define compensation for each referral step based on an affiliate's 111, 112 contribution to completion of the target action, such as based on the specific target action, the degree of influence of the affiliate 111, 112 (e.g., whether the affiliate 111, 112 was the first contact or last contact before completion of the action) and/or degree of exclusivity of the referral (e.g., whether there is a single referring affiliate 111, 112 resulting in the target action or whether there were multiple referring affiliates 111, 112).

An example of multiple referral steps resulting in completion of a single target action may be, for example, a referred consumer 135 who is first referred to the manufacturer's website 121 by an entity affiliate 112 but does not make a purchase at the first visit to the website 121. The referred consumer 135 may subsequently visit the website 121 again in response to a promotion from a retail affiliate 111 and the referred consumer 135 may make a purchase at the subsequent visit to the website 121. In this instance, the referral by the entity affiliate 112 and the retail affiliate 111 may be considered multiple referral steps resulting in the single purchase by the referred consumer 135. The manufacturer merchant 120 may wish to compensate both the entity affiliate 112 and the retail affiliate 111 for their referrals, even though only the referral by the retail affiliate 111 directly resulted in a sale. The manufacturer merchant 120 may define a compensation program in which the last referral immediately before a sale earns the most compensation compared to other referral steps (e.g., in this example, the entity affiliate 112 may earn a commission of 0.5% of the sale, while the retail affiliate may earn a commission of 1% of the sale). Other variations may be possible.

The compensation program defined by the manufacturer merchant 120 may also take into consideration the possibility that two or more referral steps (or all the referral steps) are attributed to a single affiliate 111, 112. The compensation program may also take into consideration the possibility that there is only a single referral step.

At 2104, the RNA 100 may track (e.g., using suitable tracking software 410) each consumer action and referral step over the course of a consumer's interaction with the manufacturer merchant 120, for example as described in or similar to that described in the methods disclosed herein.

At 2106, the RNA 100 may determine which affiliate(s) 111, 112 contributed to which step in the consumer's interaction, for example as described in or similar to that described in the methods disclosed herein. The RNA 100 may report the determined attribution to the manufacturer merchant 120, to clarify which affiliate(s) 111, 112 initiated and/or contributed to a customer's decision to complete a target action with the manufacturer merchant 120.

At 2108, affiliate compensation may be determined for the affiliate(s) 111, 112 identified in 2106. The compensation may be determined based on terms and conditions defined by the RNA 100 and/or based on the compensation program defined by the manufacturer merchant 120, for example as described in or similar to that described in the methods disclosed herein. The RNA 100 may broker payment of compensation to the affiliate(s) 111, 112, for example as described in or similar to that described in the methods disclosed herein.

### Example Method for Promotion Over Dedicated Retail Social Network

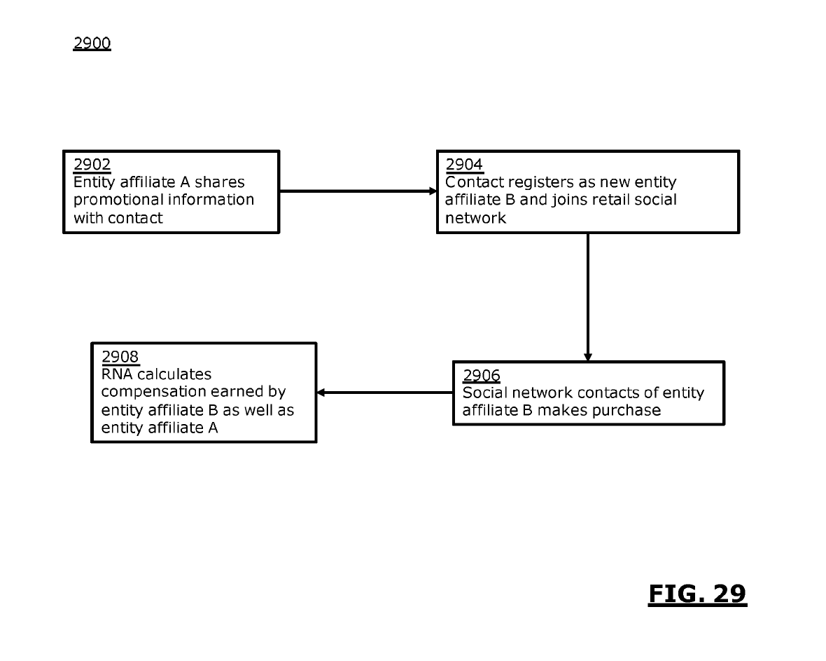

FIG. 29 is a flowchart illustrating an example method for promoting products and/or services over a dedicated retail social network, which method may be carried out by the example system of FIGS. 3 and 4.

At 2902, entity affiliate A 112a may share (e.g., through email) promotional information (e.g., a coupon, affiliate-specific link or other promotional information, such as described above) with a contact.

At 2904, in response to the promotional information, the contact may register as a new entity affiliate B 112b on the retail network 300 (e.g., as described in various methods disclosed herein). The entity affiliate B 112b may participate in a dedicated retail social network managed by the RNA 100. For example, the RNA 100 may provide the entity affiliate B 112b with an affiliate-specific social channel (e.g., ProductNetwork.com/johnsmith) and/or may assist the entity affiliate B 112b with setting up a virtual store. The entity affiliate B 112b may use the affiliate-specific social channel to share promotional information (e.g., photos, reviews, coupons and affiliate-specific links, among other possibilities) with other contacts. The social channel may provide capabilities similar to conventional social networks such as Facebook and Pinterest, for example, to simplify the process of sharing promotional information.

The retail social network may provide affiliates 112 and consumers 130, 135 with a user-friendly interface, similar to conventional social network interfaces, and may facilitate sharing of product information, promotional information, reviews, and other such information through social networking features such as status updates, tweets and photos, among others.

At 2906, contacts of entity affiliate B 112b may response to promotional information on the social channel, for example by purchasing a promoted product and/or service. This purchase may be carried out and may be tracked by the RNA 100, similar to the methods disclosed elsewhere in the present disclosure. The purchase may be attributed to the referral by entity affiliate B 112b and may also be attributed to the original referral by entity affiliate A 112a.

At 2908, the RNA 100 may calculate the compensation earned by each of entity affiliate A and B 112a, 112b resulting from the purchase, for example similar to the methods disclosed elsewhere in the present disclosure.

### Possible Variations and Possible Advantages Provided by the Present Disclosure

Possible variations of the present disclosure include:

A retail system that may include: a retail display located at a retail location of a retailer, the retail display including a representative display product, the representative display product representing a vendible product available from a supplier; information related to the representative display product; a plurality of purchase tokens available to customers; wherein the purchase tokens include product identifying information to identify the product; and a computer system operable by the retailer for receiving a purchase request from customers, the purchase request including the product identifying information.

The system may include a computer system operable by the supplier.

The representative display product may include at least one of: a physical product; an actual sample of the vendible product; a model of the vendible product; and a memory storing non-transient electronic data representing the vendible product.

The electronic data representing the vendible product may be formatted for transmission to and use by mobile computing devices.

The purchase tokens may include at least one of: coupons and a memory storing non-transient electronic data representing purchase information related to the vendible product.

The electronic data representing purchase information related to the vendible product may be formatted for transmission to and use by mobile computing devices.

The electronic data representing purchase information related to the vendible product may include a QR code.

The purchase tokens may be available at the retail display.

The information related to the representative display product may be displayed at the retail display.

The supplier may be a manufacturer of the vendible product.

A method of retailing may include: displaying a representative display product at a retail location of a retailer, the representative display product representing a vendible product available from a supplier; providing information related to the representative display product; making available a plurality of purchase tokens to customers; wherein the purchase tokens include product identifying information to identify the product; receiving a purchase request from customers, the purchase request including the product identifying information;

transacting a purchase of at least one replication of the vendible product identified by the purchase request; and arranging delivery of the at least one replication to a delivery location.

Transacting a purchase of at least one replication may be performed at the retail location.

Transacting a purchase of at least one replication may be performed on the cash-receiving system of the retail location.

The method may include paying the manufacturer for the purchased vendible product.

Transacting a purchase of at least one replication may be performed over the Internet using an Internet browser.

The method may include paying the retailer a commission for the purchased vendible product.

Transacting a purchase of at least one replication may be performed at a remote location.

Transacting a purchase of at least one replication may be performed over the Internet using an Internet browser.

Arranging delivery of the at least one replication to a delivery location may include using a delivery location provided by the customer or using the retail location as the delivery location.

A method of tracking affiliates may include: operating a computer communication system; entering respective product information into the computer communication system; generating a product code; generating a reseller code linked to the product code; providing a reseller with the reseller code; providing the reseller with a computer communication address for subsequent entry of the reseller code by a first potential affiliate; providing the reseller code for subsequent entry by the first potential affiliate; making available to the first potential affiliate a computer communication address that identifies the computer communication system information, for subsequent use by the first potential affiliate; accepting at the computer communication address the reseller code and affiliate-identifying information of the first potential affiliate; assigning a first affiliate sign-up code to the affiliate-identifying information, thereby identifying a first registered affiliate; recording in the computer communication system the first affiliate sign-up code and the associated first registered affiliate; and transmitting the first affiliate sign-up code to the first registered affiliate.

The first affiliate sign-up code may be further related to at least one of: the reseller code and the product code.

The method may include accepting payment for the product from the first registered affiliate, thereby transacting a first level product sale.

The method may include relating the payment for the product to the first affiliate sign-up code.

The method may include generating a reseller commission payable to the reseller as identified by the payment for the product from the first registered affiliate as related to the first level product sale and by the reseller code.

The method may include generating an affiliate-forwardable advertisement.

The affiliate-forwardable advertisement may include an affiliate-forwardable email for forwarding to a second potential affiliate.

The affiliate-forwardable email may contain the first affiliate sign-up code, the reseller code, and the product code.

The first affiliate sign-up code, the reseller code, and the product code may be embedded in at least one of: the affiliate-forwardable email and a URL.

The method may include accepting payment for the product from the second potential affiliate or a potential customer, thereby transacting a second level product sale.

The method may include generating an affiliate commission payable to the first registered affiliate as identified by the payment for the product from second potential affiliate or the potential customer as related to the second level product sale and by the first affiliate sign-up code for the first registered affiliate.

The method may include requesting permission from the potential affiliate or potential customer to send retail-related communications to the second potential affiliate or the potential customer, wherein the retail-related communications are related to the reseller.

The retail-related communications may be sent to the second potential affiliate or the potential customer who are located geographically adjacent the reseller, and wherein the retail-related communications geographically identify the reseller.

The reseller code may be algorithmically generated or randomly generated.

The reseller code, the product code may be presented by the reseller as an amalgamated code.

The computer communication system may be accessible through the Internet.

The communication system information may include an Internet address.

The computer communication system may include a mobile device computer application.

The method may include providing the reseller with a product to be sold by the reseller.

The method may include generating a manufacturer code that identifies the manufacturer of the product and entering the manufacturer code into the computer communication system.

The method may include relating the payment for the product to the manufacturer code.

The method may include generating a manufacturer commission payable to the manufacturer as identified by the payment for the product from the first registered affiliate as related to the first level product sale and by the manufacturer code.

The method may include linking the first affiliate sign-up code to a reseller code.

The method may include: accepting at the computer communication address the reseller code and affiliate-identifying information of the second potential affiliate; assigning a second affiliate sign-up code to the affiliate-identifying information, thereby identifying a second registered affiliate; recording in the computer communication system the second affiliate sign-up code and the associated second registered affiliate; and transmitting the second affiliate sign-up code to the second registered affiliate.

The method may include linking the first unique affiliate code and second unique affiliate code one to the other.

The affiliate identifying information may include at least one of: an email address, a telephone number and a geographical mailing address.

A method of signing-up affiliates after a purchase using a computer storage and communication system may include: (a) transacting an electronic purchase from a customer; (b) recording affiliate information received from the affiliate; (c) transmitting an affiliate sign-up offer to the customer, wherein the affiliate sign-up offer includes a submit button for accepting the affiliate sign-up offer; (d) receiving acceptance from the customer to become an affiliate, as generated by the customer invoking the function associated with the submit button; and (e) transmitting affiliate invitation information including an invitation code to the affiliate.

The method may include, subsequent to (c): transmitting to the rewards program affiliate confirmation of sign-up.

The function associated with the reply button may be invoked by a single interaction with the digital computer device.

The single interaction may include a single click of an electronic mouse button or a single touch of a touch sensitive display screen.

The invitation code may include a unique invitation code.

The invitation code may be embedded in the affiliate invitation.

The invitation code may include a URL link embedded in the affiliate invitation, wherein the URL link is to a web page related to the product for sale.

The method may include, prior to (a): generating data related to a product for sale; and storing the data in the computer storage and communication system.

The data may include a product code related to the product for sale, and the method may include presenting or transmitting the product code to the participant.

The product code may be embedded in the affiliate invitation.

The method may include transmitting a gift certificate to the customer.

A method of establishing ongoing communications to a customer, using a computer storage and communication system, including: (a) transacting an electronic purchase from a customer; (b) receiving customer information from the customer and recording the customer information; (c) transmitting a give-away offer to the customer according to the customer information, wherein the give-away offer includes a software button for accepting the give-away offer; (d) receiving acceptance of the give-away offer from the customer, as generated by the customer invoking the function associated with the software button; and (e) transmitting a give-away to the customer according to the customer information.

The reward offer may be displayable on a display screen of a digital electronic computer/communication device, and may include data fields displayed with the customer information pre-populated in at least some of the fields.

A method of establishing ongoing communications to a customer, using a computer storage and communication system, the method may include: (a) transacting an electronic purchase from a customer; (b) receiving customer information from the customer; (c) recording the customer information; (d) offering reward to the customer; (e) presenting a statement regarding sending subsequent communications to the customer; (f) receiving acceptance from the customer of the offer made to the customer; (g) sending the reward to the customer; and (h) sending subsequent communications to the customer according to the presented statement.

Offering reward to the customer may include electronically transmitting an offer of a reward to the customer.

Electronically transmitting an offer of a reward to the customer may include providing a software button for accepting the reward.

Electronically transmitting an offer of a reward to the customer may include displaying data fields having the customer information pre-populated in at least some of the fields.

The acceptance from the customer of the offer made to the customer may be generated by the customer selecting the software button.

Selecting the software button may be performed by a single interaction with a digital computer device.

The present disclosure may provide one or more advantages over conventional retail methods.

For example, the manufacturer merchant 120 may enjoy one or more of the following advantages:
may enjoy revenue immediately from direct online purchases by a consumer
may be able to form a direct relationship with the end-consumer, which may allow ongoing direct sales to that consumer, giving the manufacturer merchant 120 more control than in the conventional retail model
may have easier access and ability to promote through retail stores with little or no capital cost associated with inventory
may be able to carry out market testing (e.g., to test products, packages, offers, and prices)
may be able to give away products to drive customer awareness (e.g., through online presence of affiliates 111, 112)
may be able to reach consumers (who may not be typically accessible to a manufacturer) by marketing through non-conventional retailers and non-retail environments
may be able to leverage a network of resellers quickly through the established affiliate network (e.g., through online “refer-a-friend” programs)
may benefit from historical data and analytics 414 captured and stored by the RNA 100 from previous sales and promotions
may be able to manage product returns more easily without the usual inventory-handling cost of product recalls
may reduce or eliminate bad debt with retailers
may be able to set up promotions at otherwise expensive retail locations more effectively with reduced costs compared to conventional retailing
may be able to reach the target audience more effectively by leveraging relationships between the RNA and its participating affiliates
may be able to promote larger and more expensive products through retail more easily by reducing or eliminating inventory costs
may gain more exposure in non-retail environments, including conventionally non-retail public locations such as hospitals, dentists, doctor's offices, and restaurants
may be able to convert a magazine ad and/or a display ad (e.g., an electronic display) into a retail purchasing opportunity or virtual store promotion
may have leverage over retailers who do not pay for inventory from manufacturer, by the manufacturer being able to withhold commission from the retailer

Such advantages may be enabled by the RNA 100, which may differ from conventional product distributors and resellers in various ways, for example including one or more of the following differences:
retailers who are retail affiliates 111 may be able to reduce or eliminate inventory costs (e.g., costs associated with ordering, handling, and managing inventory) while still promoting products in a retail showroom setting
retail affiliates 111 may also encourage store visitors to become entity affiliates 112 and the retail affiliate 111 may earn compensation for sales generated by the entity affiliates 112
promotions may allow manufacturer merchants 120 to offer more compelling offers (e.g., lower prices) while leveraging the retail store as a showroom, and may provide an incentive for retailers and in-store visitors to promote products and/or services through social sharing and online marketing
the RNA 100 may not have to buy the product, warehouse the product and re-ship the product to retailers, which may result in reduction or elimination of inventory cost for the RNA 100
the RNA 100 may be managing relationships, commissions and information, rather than physical products
the RNA 100 may provide support that may allow manufacturers to increase the number of retail stores that can carry or represent their products and/or services, while reducing the amount of inventory that needs to be in the market
the RNA 100 may form an ongoing, direct relationship with the consumer over the course of the consumer buying from the merchant manufacturer 120
the RNA 100 may gather and provide analytics data 414 to retailers and/or manufacturers
the RNA 100 may not sell products directly to the retailer
the RNA 100 may underwrite a transaction and may provide a guarantee to ensure consumer satisfaction (and may deduct any cost of ensuring product satisfaction from the manufacturer), which may make it safer and/or more trustworthy for consumers to buy from a manufacturer that is approved by the RNA 100 and for which the RNA 100 may provide third-party validation, assurance and/or guarantee.
information gathered by the RNA 100 (e.g., on various regions or retail stores) may be used by retailers and/or manufacturers to forecast demand for products, develop better marketing/promotion opportunities for new products during the go-to-market planning phase, help in product launch planning, and better target promotions based on consumer interests and past purchase behavior, among other uses
the RNA 100 may act as a trusted third-party broker for transactions among entities in the retail network 300, in contrast to conventional retail models in which retailers must deal directly with a manufacturer, which may lead to a level of distrust
the RNA 100 may act as an insurer against any breach of agreement or default by any entity in the retail network 300, for example by ensuring that a retail affiliate 111 still receives compensation owed (e.g., drawn from the RNA's 100 own assets) even if the manufacturer merchant 120 files for bankruptcy

A retail affiliate 111 may benefit from services of the RNA 100 in various ways. For example, the services provided by the RNA 100 may allow smaller independent retailers to compete with major retail chains, by enabling leverage of economies of scale (e.g., of online retail methods) and/or the power of analytics.

A consumer 112, 130, 135 may benefit from services of the RNA 100 in various ways, such as one or more of the following:
the consumer 112, 130, 135 may not need to wait for a physical store to open
there may be a reduction in risk of buying products without a physical demo (thus the consumer 112, 130, 135 may benefit from both the cost savings of online retail and the proof of a physical in-store demo)
the consumer 112, 130, 135 may be able to carry out repeat orders more easily (e.g., such orders may be automated and managed by the RNA 100) for certain products
the consumer 112, 130, 135 may enjoy cost savings from better pricing due to economies of scale

It should be understood that various variations to the examples and embodiments disclosed herein may be possible.

For example, product(s) and/or service(s) may be promoted by personalized product recommendations, based on what other consumers purchased (e.g., a consumer may be presented with recommendations based on what other consumers bought, such as “Others who bought X also bought Y”).

A consumer may be provided with flexible delivery options. For example, a consumer may view an item in a retail store and get home delivery or in-store pickup, depending on the consumer's preference.

A loyalty program may be implemented through the RNA 100. For example, the RNA 100 may track and manage loyalty points earned by an entity affiliate 112 through purchases at participating manufacturer merchants 120 and/or retail affiliates 111.

Entity affiliates 112 may be able to apply for different levels of membership in the affiliate network 300. For example, an entity affiliate 112 may pay an annual fee (e.g., $50) in order to get better discounts at participating manufacturer merchants 120 and/or retail affiliates 111, and/or in order to get better compensation rates.

In some examples, rather than paying compensation to entity affiliates 112, compensation may be earned in the form of points or credits that may be used towards purchases at participating manufacturer merchants 120 and/or retail affiliates 111. For example, instead of a $5 commission, an entity affiliate 112 may earn 6 credits, which may be tracked and recorded by the RNA 100 in the consumer database 404.

The RNA 100 may provide services to enable customer feedback and reviews for products and/or services. Because the RNA 100 may vet who can join as entity affiliates 112 and may police customer feedback, the RNA 100 may provide a trusted source of consumer reviews. In some examples, if a manufacturer merchant 120 is associated with a large number of negative reviews (e.g., an average rating below 50%), the manufacturer merchant 120 may be reprimanded and/or may have its association with the retail network 300 revoked.

The RNA 100 may act as a trusted entity for product returns. For example, even where a manufacturer merchant 120 is not trustworthy, the RNA 100 may guarantee a product refund. This may be an improvement over conventional direct e-commerce orders from a manufacturer.

The present disclosure may provide a way to incent customers in waiting situations (e.g., at dentists, auto-care, hair dresser, and other retail or non-retail environments) to make a purchase while waiting (e.g., by providing a discount on in-store services). For example, an auto-care centre may incent a consumer to make a purchase while waiting (e.g., using promotional material, such as an electronic display, provided by the RNA 100), and get a discount on an oil change at the auto-care centre. The consumer may be required to show proof of the purchase (e.g., a purchase confirmation email) at the time of paying for the service they were waiting for. Such co-promotions may also be carried out in other ways, for example proof of an online purchase may be used for discount on other online purchases or for redemption of a gift, among other possibilities.

Conversely, purchase of a service in a non-retail environment may result in a discount or coupon for redemption when buying a product from a manufacturer merchant 120. For example, a promotion at a waiting area of a retail affiliate 111 (who may or may not be a retailer in the conventional sense) may advertise that purchase of a service at full price will earn a discount off a product purchased through the promotion (e.g., purchase of an oil change at an auto-care centre may generate a 5% discount off the purchase of a product promoted at a display in the auto-care centre). The discount may be provided by retail affiliate 111 out of the commission the retail affiliate 111 would earn from sale of the promoted product. This may be a mechanism by which a retail affiliate 111 may increase its referral rate and/or may increase the number of its referred consumers 135, which may translate into further income for the retail affiliate 111. In some examples, the consumer may be offered a gift card or coupon instead of a discount.

The present disclosure may provide a mechanism for gift-giving (e.g., gifting of flowers or gifting of promoted products and/or services). The RNA 100 may provide further services, such as managing sharing features (e.g., similar to a social-sharing network, such as Pinterest), reminding entity affiliates 112 of gift-giving occasions (e.g., anniversaries, birthdays or celebratory holidays) and/or suggesting appropriate products and/or services for such occasions, among other possibilities.

In some examples, the RNA 100 may provide software, such as mobile apps and social media apps, to help affiliates 111, 112 to promote products and/or services. For example, on a social media website (e.g., Facebook), an entity affiliate 112 could give a contact a virtual product with an affiliate-specific link to a website 121 to purchase the actual product.

Although the present disclosure describes two tiers of compensation (that is, purchase by a referred consumer 135 results in compensation both to affiliate A 111, 112 who directly referred the consumer 135 but also to the affiliate B 111, 112 who recruited affiliate A 111, 112), other compensation structures (with more or less tiers) may be suitable.

In some examples, a consumer may automatically be registered as an entity affiliate 112 with the network 300 when the consumer purchases a product on a manufacturer's website 121 (including creation, by the RNA 100, of a new entry in the entity database 404 and/or creation of an affiliate-specific link for the product). The RNA 100 may communicate with the newly registered entity affiliate 112 to inform the affiliate 112 of the registration and to encourage the affiliate 112 to promote the product using the newly created affiliate-specific link. In some examples, the newly registered entity affiliate 112 may be required to activate an account (e.g., including setting up a password for a web portal to the RNA 100) in order to begin promoting the product. In some examples, the newly registered entity affiliate 112 may request deregistration from the network 300, in which case the RNA 100 may remove the affiliate's 112 information from the entity database 404.

Although the present disclosure describes transactions taking place via a manufacturer's website 121, it should be understood that purchases and other ecommerce transactions may take place in any suitable manner including, for example, purchases through a mobile app, through a social media app, as well as through other communications such as by telephone or by fax.

The steps and/or operations in the flowcharts and drawings described herein are for purposes of example only. Variations to these steps and/or operations may be possible within the scope of the present disclosure. For instance, the steps may be performed in a differing order, or steps may be added, deleted, or modified.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two, or in any other manner. Moreover, the present disclosure is also directed to a pre-recorded storage device or other similar non-transient computer readable medium including program instructions stored thereon for performing the methods described herein, including DVDs, CDs, volatile or non-volatile memories, or other storage media, for example.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two, or in any other manner. Moreover, the present disclosure is also directed to a pre-recorded storage device or other similar computer readable medium including program instructions stored thereon for performing the methods described herein.

The embodiments of the present disclosure described above are intended to be examples only. Alterations, modifications and variations to the disclosure may be made without departing from the intended scope of the present disclosure. The present disclosure may be embodied in other specific forms. While the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. Selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1. A system for managing a retail network, the system comprising a processor configured to execute computer readable instructions to cause the system to:
manage retail transactions between at least one manufacturer and/or merchant of a product or service and at least one retail affiliate having a physical space for showcasing the product or service;
wherein managing retail transactions include:
providing at least one promotional material to the at least one retail affiliate, for promoting the product or service in the physical space of the at least one retail affiliate;
providing affiliate-specific data to each of the at least one retail affiliate for communication to one or more consumers, the affiliate-specific data being unique to each of the at least one retail affiliate and usable by the one or more consumers for online purchase of the product or service;
tracking online purchase of the product or service by the one or more consumers, and attributing the online purchase as a referral by a particular one of the at least one retail affiliate, using the affiliate-specific data; and
managing transfer of compensation from the at least one manufacturer and/or merchant to the particular one retail affiliate, as a result of the tracked online purchase.

2. The system of claim 1, wherein the promotional material comprises an in-store display for display in the physical space.

3. The system of claim 2, wherein the in-store display comprises at least one of a physical representation and an electronically generated representation of the product or service.

4-6. (canceled)

7. The system of claim 1, wherein the instructions further cause the system to:
accept a consumer as an entity affiliate, the consumer having been referred by the particular one retail affiliate;
and managing retail transactions further comprise:
providing affiliate-specific data to the entity affiliate for communication to one or more contacts, the affiliate-specific data being unique to the entity affiliate and usable by the one or more contacts for online purchase of the product or service;
tracking online purchase of the product or service by the one or more contacts, and attributing the online purchase as a referral by both the entity affiliate and the particular one retail affiliate, using the affiliate-specific data; and
managing transfer of compensation from the at least one manufacturer and/or merchant to the entity affiliate, as a result of the tracked online purchase.

8. The system of claim 7, wherein managing retail transactions further comprise managing transfer of compensation from the at least one manufacturer and/or merchant to the particular one retail affiliate, as a result of the tracked online purchase.

9. The system of claim 7, wherein the instructions further cause the system to:
generate an invitation to register as an entity affiliate, the invitation being presented to the one or more customers as part of an online purchase process.

10. The system of claim 7, wherein the online purchase is carried out through a virtual store managed by the entity affiliate, the one or more contacts being directed to the virtual store by the affiliate-specific data unique to the entity affiliate.

11. The system of claim 1, wherein managing retail transactions further comprise providing virtual and/or physical coupons for distribution to one or more consumers, the coupons including the affiliate-specific data.

12-14. (canceled)

15. The system of claim 1 wherein the product or service is a new product or service, and the promotional material includes a promotional preview of the new product or service; and wherein the affiliate-specific data includes a promotional code for a promotion offered by the promotional preview.

16-19. (canceled)

20. The system of claim 1, wherein the affiliate-specific data is communicable to the one or more consumers by display in a physical space of the affiliate, in association with the product or service or in association with the promotional material for the product or service.

21. The system of claim 20, wherein the affiliate-specific data comprises at least one of: a URL link, a QR code, a barcode, and a unique promotional code.

22-46. (canceled)

47. A system for promoting a product or service, the system comprising a processor configured to execute computer readable instructions to cause the system to:
manage retail transactions between at least one manufacturer and/or merchant of a product or service and at least one entity affiliate;
wherein managing retail transactions include:
providing the at least one entity affiliate with promotional material for promoting the product or service to one or more contacts;
generating and providing to the at least one entity affiliate affiliate-specific data unique to each of the at least one entity affiliate, the affiliate specific data being communicable to the one or more contacts and usable by the one or more contacts for online purchase of the product or service;
tracking online purchase of the product or service by the one or more contacts, and attributing the online purchase as a referral by a particular one of the at least one entity affiliate, using the affiliate-specific data; and
managing transfer of compensation from the at least one manufacturer and/or merchant to the particular one entity affiliate, as a result of the tracked online purchase.

48. The system of claim 47, wherein the promotional material is communicable electronically.

49-50. (canceled)

51. The system of claim 47, wherein the instructions further cause the system to:
accept a contact as a new entity affiliate, the contact having been referred by an originating entity affiliate; and
manage retail transactions with the new entity affiliate.

52. The system of claim 51, wherein attributing the online purchase comprises attributing the online purchase as a referral by the originating entity affiliate as well as a referral by the new entity affiliate, and wherein compensation is transferred to both the originating entity affiliate and the new entity affiliate.

53-54. (canceled)

55. The system of claim 47 further comprising at least one database for storing the affiliate-specific data in association with the at least one entity affiliate.

56-58. (canceled)

59. A system for managing a retail network, the system comprising a processor configured to execute computer readable instructions to cause the system to:
manage retail transactions with at least one affiliate;
wherein managing retail transactions include:
providing promotional material to the at least one affiliate;
generating and providing affiliate-specific data to each of the at least one affiliate for communication to one or more consumers, the affiliate-specific data being unique to each of the at least one affiliate and usable by the one or more consumers for online purchase of the product or service;
tracking online purchase of the product or service by the one or more consumers, and attributing the online purchase as a referral by a particular one of the at least one affiliate, using the affiliate-specific data; and
managing transfer of compensation to the particular one affiliate, as a result of the tracked online purchase.

60. The system of claim 59, wherein the at least one affiliate comprises at least one retail affiliate having a physical space for showcasing the product or service, and wherein the promotional material includes at least one in-store promotional display for display in the physical space of the at least one retail affiliate.

61. The system of claim 60 wherein the affiliate-specific data is communicable to the one or more consumers by display in the physical space, in association with the product or service or in association with the promotional material.

62. The system of claim 59, wherein the at least one affiliate comprises at least one entity affiliate.

63-68. (canceled)
